(19) United States
(12) Patent Application Publication
(10) Pub. No.: US 2026/0226212 A1
(43) Pub. Date: Aug. 6, 2026

(54) Bottlebrush Poly(alpha olefin) Networks

(71) Applicant: ExxonMobil Technology and Engineering Company, Spring, TX (US)

(72) Inventors: Carlos R. Lopez-Barron, Houston, TX (US); Tzu-Pin Lin, Houston, TX (US)

(21) Appl. No.: 19/460,719

(22) Filed: Jan. 27, 2026

Related U.S. Application Data
(60) Provisional application No. 63/753,050, filed on Feb. 3, 2025.

(51) Int. Cl. C08F 210/18; C08F 4/76; C08J 3/24; C08K 3/06; C08K 5/14

(52) U.S. Cl. CPC C08F 210/18; C08F 4/76; C08J 3/247; C08K 3/06; C08K 5/14; C08F 2500/36; C08J 2323/24

(57) ABSTRACT

Embodiments of the present disclosure generally relate to polymer compositions and methods to prepare polymer compositions. In one or more embodiments, a method for preparing a poly(alpha olefin) terpolymer is provided and includes introducing ethylene, one or more linear α-olefin monomers, one or more non-conjugated diene monomers, and a catalyst system to a first reactor to form a reaction mixture, the catalyst system represented by Formula (V), polymerizing the reaction mixture to form a linear polymer, and vulcanizing the polymer mixture to form a polymer composition containing the poly(alpha olefin) terpolymer. In other embodiments, a polymer composition is provided and includes a poly(alpha olefin) terpolymer prepared from a reaction product of: ethylene, one or more linear α-olefin monomers containing an unsubstituted C₂ to C₄₀ alpha olefins, and one or more non-conjugated diene monomers, wherein the poly(alpha olefin) terpolymer has a complex modulus of about 1 kPa to about 100 kPa.

### CROSS REFERENCE TO RELATED APPLICATIONS

This application claims the benefit of and priority to U.S. Provisional Application No. 63/753,050 filed Feb. 3, 2025, the disclosure of which is incorporated herein by reference.

### FIELD

The present disclosure relates to poly(alpha-olefin) (PAO) polymers and production of PAO polymers. More specifically, the present disclosure relates to bottlebrush poly(alpha olefin) terpolymers and methods of producing bottlebrush poly(alpha olefin) terpolymers.

### BACKGROUND

Cross-linked polymers are used in numerous industrial and consumer applications, such as for coatings, seals, tires, tubing, and roofing, among many others. Cross-linked polymers can be composed of vulcanized natural rubbers, polybutadiene, styrene-butadiene copolymers, acrylonitrile-butadiene rubbers, polyisoprene, isoprene-isobutylene copolymers, ethylene-propylene, ethylene propylene diene monomer (EPDM) rubbers, silicone elastomers, fluoroelastomers, polyurethane elastomers, and nitrile rubbers, among others. Cross-linked polymers can be advantageous for combining toughness, elasticity, and resistance to heat, chemicals, and other environmental factors. However, cross-linked polymers also have important disadvantages. For instance, cross-linked polymers cannot flow, even at elevated temperature, due to their relatively high cross-linking density. Furthermore, cross-linked polymers cannot be reprocessed because their cross-linking is irreversible.

One such cross-linked polymer is poly(alpha olefin) (PAO) polymers. PAO polymers can be used in phase change materials (PCMs). Unfortunately, PAO polymers undergo leakage when in the liquid state, thereby reducing functionality of the PAO polymer. Conventional approaches to reducing leakage have included integrating porous supports with the PAO polymers to fabricate shape-stabilized phase change materials (ss-PCMs). However, this does not fully eliminate the leaking problem and increases manufacturing costs.

Thus, there is a need to develop new, more efficient processes for large scale production of PAO polymers.

### SUMMARY

Embodiments of the present disclosure generally relate to polymer compositions and methods to prepare polymer compositions, more specifically to poly(alpha olefin) terpolymers and production of poly(alpha olefin) terpolymers.

Embodiments of the present disclosure generally relate to polymer compositions and methods to prepare polymer compositions. In one or more embodiments, a method for preparing a poly(alpha olefin) terpolymer is provided and includes introducing ethylene, one or more linear α-olefin monomers, one or more non-conjugated diene monomers, and a catalyst system to a first reactor to form a reaction mixture, the catalyst system represented by Formula (V), polymerizing the reaction mixture to form a linear polymer, and vulcanizing the polymer mixture to form a polymer composition containing the poly(alpha olefin) terpolymer. The catalyst system represented by Formula (V) is:

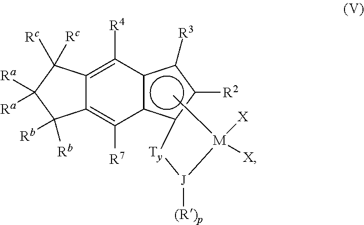

wherein: M is a group 4 metal; J is N, O, S, or P; p is 1 when J is N or P, and is 0 when J is O or S; each R², R³, R⁴, and R⁷ is independently hydrogen, or a C₁-C₅₀ substituted or unsubstituted hydrocarbyl, halocarbyl, silylcarbyl, or germylcarbyl; R′ is a C₁-C₁₀₀ substituted or unsubstituted hydrocarbyl, halocarbyl, silylcarbyl, substituted hydrocarbyl rings, unsubstituted hydrocarbyl rings, substituted heterocyclic rings, or unsubstituted heterocyclic rings each having 5, 6, 7, or 8 ring atoms; T is (CR⁸R⁹)ₓ, SiR⁸R⁹ or GeR⁸R⁹ where x is 1 or 2, each R⁸ and R⁹ is independently selected from hydrogen or substituted or unsubstituted hydrocarbyl, halocarbyl, silylcarbyl, and germylcarbyl and R⁸ and R⁹ may optionally be bonded together to form a ring structure; y is 0 or 1; each X is C₁-C₁₀₀ alkyl; and each R^{a}, R^{b}, and R^{c} is independently C₁-C₁₀ alkyl or hydrogen.

In other embodiments, a polymer composition is provided and includes a poly(alpha olefin) terpolymer prepared from a reaction product of: ethylene, one or more linear α-olefin monomers containing an unsubstituted C₂ to C₄₀ alpha olefins, and one or more non-conjugated diene monomers, selected from 2-ethylidene-5-norborene, 5-vinyl-2-norbornene, norbornadiene,

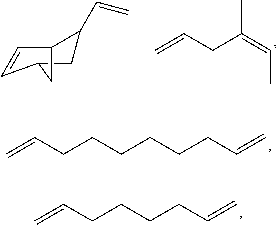

or any combination thereof. The poly(alpha olefin) terpolymer contains a complex modulus of about 1 kPa to about 100 kPa.

### BRIEF DESCRIPTION OF DRAWINGS

So that the manner in which the above recited features of embodiments of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a flow diagram depicting a method of preparing a poly(alpha olefin) terpolymer, according to one or more embodiments described and discussed herein.

FIGS. 2A-2C are graphs illustrating cure kinetics of a first poly(alpha olefin) terpolymer, according to one or more embodiments described and discussed herein.

FIGS. 3A-3C are graphs illustrating cure kinetics of a second poly(alpha olefin) terpolymer, according to one or more embodiments described and discussed herein.

FIGS. 4A and 4B are graphs illustrating dynamic frequency sweeps of the second poly(alpha olefin) terpolymer, according to one or more embodiments described and discussed herein.

FIGS. 5A and 5B are graphs illustrating stress strain of the second poly(alpha olefin) terpolymer, according to one or more embodiments described and discussed herein.

FIGS. 6A-6C are images illustrating stress strain of the second poly(alpha olefin) terpolymer, according to one or more embodiments described and discussed herein.

FIGS. 7A-7C are graphs illustrating compressive stress of various second poly(alpha olefin) terpolymers, according to one or more embodiments described and discussed herein.

FIGS. 8A-8C are graphs illustrating maximum stress, compressive set, and hysteresis loss of various second poly(alpha olefin) terpolymers, according to one or more embodiments described and discussed herein.

FIGS. 9A-9C are images illustrating compressive strain of the second poly(alpha olefin) terpolymer, according to one or more embodiments described and discussed herein.

### DETAILED DESCRIPTION

The present disclosure provides a method for the production of poly(alpha olefin) terpolymers composed of ethylene, one or more additional linear α-olefin monomers, and one or more non-conjugated diene monomer units. The poly(alpha olefin) terpolymers disclosed herein include a reduced and/or hindered fluidity above the melting temperature, thereby allowing phase change materials (PCMs) having reduced and/or eliminated leakage to be produced by the poly(alpha olefin) terpolymers of the present disclosure. Moreover, PCMS produced by the poly(alpha olefin) terpolymers of the present disclosure are self-supportive, thereby reducing and/or eliminating integration of porous supports with the poly(alpha olefin) terpolymers of the present disclosure. Without being bound by theory, the poly(alpha olefin) terpolymers of the present disclosure can include an elastic modulus in a range from 1 kPa to about 0.2 MPa, a latent heat, measured by DSC, from 100 J/g to 200 J/g, and melting temperatures between 15° C. to 35° C., thereby improving the efficacy as a PCM.

The term “and/or” refers to both the inclusive “and” case and the exclusive “or” case, and such terms are used herein for brevity. For example, a composition comprising “A and/or B” may comprise A alone, B alone, or both A and B; and a composition comprising “A and or B” may comprise A alone, or both A and B.

The percentage of a particular monomer in a polymer is expressed herein as weight percent (wt %) based on the total weight of the polymer present. Other percentages are expressed as weight percent (wt %), based on the total weight of the particular composition present, unless otherwise noted. Room temperature is 25° C.±2° C. and atmospheric pressure is 101.325 kPa unless otherwise noted.

For purposes herein a “polymer” refers to a compound having two or more “mer” units (see below for polyester mer units), that is, a degree of polymerization of two or more, where the mer units can be of the same or different species. A “homopolymer” is a polymer having mer units that are the same species. A “copolymer” is a polymer having two or more different species of mer units. A “terpolymer” is a polymer having three different species of mer units. “Different” in reference to mer units indicates that the mer units differ from each other by at least one atom or are different isomerically. Unless otherwise indicated, reference to a polymer herein includes a copolymer, a terpolymer, or any polymer comprising a plurality of the same or different species of repeating units.

The term “residue” or “unit”, as used herein, means the organic structure of the monomer in its as-polymerized form as incorporated into a polymer, e.g., through polymerization of the corresponding monomer. Throughout the specification and claims, reference to the monomer(s) in the polymer is understood to mean the corresponding as-polymerized form or residue of the respective monomer.

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of about 35 wt % to about 55 wt %, it is understood that the mer unit in the copolymer is derived from ethylene in the polymerization reaction and the derived units are present at about 35 wt % to about 55 wt %, based upon the weight of the copolymer.

As used herein, the terms “polyethylene polymer,” “polyethylene copolymer,” “polyethylene,” “ethylene polymer,” “ethylene copolymer,” and “ethylene based polymer” mean a polymer or copolymer comprising at least 50 mole percent (mol %) ethylene units, or at least 70 mol % ethylene units, or at least 80 mol % ethylene units, or at least 90 mol % ethylene units, or at least 95 mol % ethylene units or 100 mol % ethylene units (in the case of a homopolymer).

As used herein, a “polymer” may refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated or unsaturated), including mixtures of hydrocarbon compounds having different values of n.

As used herein, a composition or film “free of” a component refers to a composition/film substantially devoid of the component, or comprising the component in an amount of less than 0.01 wt %, by weight of the total composition.

For the purposes of the present disclosure, the numbering scheme for the Periodic Table Groups is used as described in Chemical and Engineering News, v. 63(5), pg. 27 (1985).

The following abbreviations may be used herein: Me is methyl, Et is ethyl, Ph is phenyl, PDI is polydispersity index, NMR is nuclear magnetic resonance, ppm is part per million, THF is tetrahydrofuran.

The terms “substituent,” “radical,” “group,” and “moiety” may be used interchangeably.

The term “alpha-olefin” or “α-olefin” refers to an olefin having a terminal carbon-to-carbon double bond in the structure thereof ((R″R′″)—C═CH₂, where R″ and R′″ can be independently hydrogen or any hydrocarbyl group; such as R″ is hydrogen and R′″ is an alkyl group). A “linear alpha-olefin” or “linear α-olefin” is an alpha-olefin defined in this paragraph wherein R″ is hydrogen, and R′″ is hydrogen or a linear alkyl group.

For the purposes of the present disclosure, ethylene shall be considered an alpha-olefin.

As used herein, and unless otherwise specified, the term “Cₙ” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted aromatic,” means an aromatic group having 1 or more hydrogen groups replaced by a hydrocarbyl, substituted hydrocarbyl, heteroatom or heteroatom containing group.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” “alkyl group,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues. Some examples of alkyl may include 1-methylethyl, 1-methylpropyl, 1-methylbutyl, 1-ethylbutyl, 1,3-dimethylbutyl, 1-methyl-1-ethylbutyl, 1,1-diethylbutyl, 1-propylpentyl, 1-phenylethyl, 1-propyl, 2-butyl, sec-pentyl, sec-hexyl, and the like.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mₙ is number average molecular weight, M_{w} is weight average molecular weight, and M_{z} is z average molecular weight, wt % is weight percent, and mol % is mole percent. Molecular weight distribution (MWD), also referred to as polydispersity index (PDI), is defined to be M_{w} divided by Mₙ. Unless otherwise noted, all molecular weight units (e.g., M_{w}, Mₙ, M_{z}) are g/mol.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by Formulae herein are intended to embrace both neutral and ionic forms of the catalyst compounds and activators.

An “anionic ligand” is a negatively charged ligand which donates one or more pairs of electrons to a metal ion. A “Lewis base” or “neutral donor ligand” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example, a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert diluent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

A bulk polymerization means a polymerization process in which the monomers and or comonomers being polymerized are used as a solvent or diluent using little or no inert solvent as a solvent or diluent. A small fraction of inert solvent/diluent might be used as a carrier for catalyst and scavenger. A bulk polymerization system contains less than 25 wt % of inert solvent or diluent, such as less than 10 wt %, such as less than 1 wt %, such as 0 wt %.

The term “single catalyst compound” refers to a catalyst compound corresponding to a single structural formula, although such a catalyst compound may comprise and be used as a mixture of isomers, e.g., stereoisomers.

A catalyst system that utilizes a single catalyst compound means a catalyst system that is prepared using only a single catalyst compound in the preparation of the catalyst system. Thus, such a catalyst system is distinguished from, for example, “dual” catalyst systems, which are prepared using two catalyst compounds having different structural formulas, e.g., the connectivity between the atoms, the number of atoms, and/or the type of atoms in the two catalyst compounds is different. Thus, one catalyst compound is considered different from another if it differs by at least one atom, either by number, type, or connection. For example, bisindenyl zirconium dichloride is different from (indenyl)(2-methylindenyl) zirconium dichloride which is different from (indenyl)(2-methylindenyl) hafnium dichloride. Unless otherwise noted, catalyst compounds that differ only in that they are stereoisomers of each other are not considered to be different catalyst compounds. For example, rac-dimethylsilylbis(2-methyl 4-phenyl)hafnium dimethyl and meso-dimethylsilylbis(2-methyl 4-phenyl)hafnium dimethyl are considered to be not different.

The terms “cocatalyst” and “activator” are used herein interchangeably and are defined to be any compound which can activate any one of the catalyst compounds described above by converting the neutral catalyst compound to a catalytically active catalyst compound cation.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, “in a range” or “within a range” includes every point or individual value between its end points even though not explicitly recited and includes the end points themselves. Thus, every point or individual value may serve as its own lower or upper limit combined with any other point or individual value or any other lower or upper limit, to recite a range not explicitly recited.

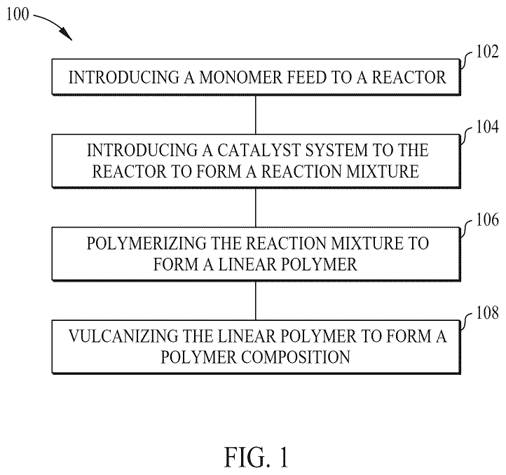

FIG. 1 shows a process flow diagram of a method 100 for forming poly(alpha olefin) terpolymers. The method 100 can include introducing a monomer feed and a catalyst system to a reactor to form a reaction mixture that is subsequently polymerized to form a polymer mixture. At operation 102 of the method 100, a monomer feed may be introduced to a first reactor. The monomer feed may include one or more olefin monomers. The olefin monomer may include ethylene or a combination of ethylene and one or more olefin monomers. The olefin monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the olefin monomer includes ethylene and a first comonomer, in which the first comonomer includes one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In at least one embodiment, the first comonomer includes linear α-olefin monomers. The linear α-olefin monomers include substituted or unsubstituted C₂ to C₄₀ alpha olefins, such as propylene, butene, pentene, hexene, heptene, octene, nonene, decene, undecene, dodecene, 1-octadecene, and isomers thereof. For example, the linear α-olefin monomers can include unsubstituted C₁₀ to C₁₈ alpha olefins.

In another embodiment, the monomer includes ethylene, a first comonomer, and a second comonomer. The second comonomer may be or include one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In at least one embodiment, the second comonomer includes non-conjugated diene monomers. The non-conjugated diene monomers include substituted or unsubstituted C₂ to C₄₀ olefins, such as 2-ethylidene-5-norborene, 5-vinyl-2-norbornene, norbornadiene,

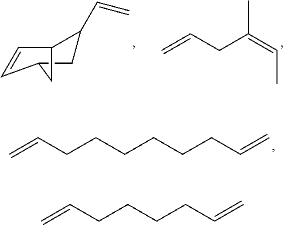

or any combination thereof.

In some embodiments, the monomer feed includes a solvent and/or diluent. Suitable diluents/solvents include non-coordinating, inert liquids. In at least one embodiment, a solvent/diluent includes straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In some embodiments, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, in some examples, aromatics are present in the solvent at less than 1 wt %, such as less than 0.5 wt %, such as less than 0 wt % based upon the weight of the solvents.

In at least one embodiment, the monomer feed includes a solvent in an amount of about 80 volume percent (vol %) or less, based on the total volume of the of the monomer feed. In at least one embodiment, the monomer feed includes a solvent in an amount of about 80 wt %, based on the total weight of the monomer feed.

In some embodiments, the monomer feed is introduced to the reactor at a rate of about 0.1 L/min to about 20 L/min. In some of these examples, the reactor has a size in a range from about 2 L to about 16 L. In some embodiments, the monomer feed includes ethylene, a C₁₀-C₁₈ linear α-olefin monomer, and 2-ethylidene-5-norborene. The ethylene may be introduced to the reactor at a feed rate of about 0.1 L/min to about 10 L/min, about 0.1 L/min to about 8 L/min, about 0.1 L/min to about 6 L/min, about 0.1 L/min to about 5 L/min, about 0.1 L/min to about 4 L/min, about 0.1 L/min to about 3 L/min, about 0.1 L/min to about 2.8 L/min, about 0.1 L/min to about 2.5 L/min, such as about 0.5 L/min to about 2 L/min, such as about 1 L/min to about 1.5 L/min, alternatively about 0.1 L/min to about 0.5 L/min, alternatively about 0.5 L/min to about 1 L/min, alternatively about 1.5 L/min to about 2 L/min, alternatively about 2 L/min to about 2.5 L/min. The C₁₀-C₁₈ linear α-olefin monomer may be introduced to the reactor at a feed rate of about 1 g/min to about 25 g/min, such as about 5 g/min to about 20 g/min, such as about 10 g/min to about 15 g/min, alternatively about 1 g/min to about 5 g/min, alternatively about 5 g/min to about 10 g/min, alternatively about 15 g/min to about 20 g/min, alternatively about 20 g/min to about 25 g/min. The 2-ethylidene-5-norborene may be introduced to the reactor at a feed rate of about 0.01 mL/min to about 10 mL/min, about 0.01 mL/min to about 8 mL/min, about 0.01 mL/min to about 6 mL/min, about 0.01 mL/min to about 5 mL/min, such as about 0.1 mL/min to about 2.5 mL/min, such as about 0.5 mL/min to about 2 mL/min, alternatively about 0.01 mL/min to about 0.1 mL/min, alternatively about 0.1 mL/min to about 0.5 mL/min, alternatively about 0.5 mL/min to about 1 mL/min, alternatively about 1 mL/min to about 2 mL/min, alternatively about 2 mL/min to about 5 mL/min, alternatively about 5 mL/min to about 10 mL/min, alternatively about 2 mL/min to about 2.5 mL/min, alternatively about 2.5 mL/min to about 5 mL/min.

At operation 104 of the method 100, a catalyst system may be introduced to or otherwise combined with the reactor with the monomer feed to produce a reaction mixture, e.g., blending, stirring, beating, turbulent flow, dispersion, or combinations thereof. A catalyst system may include a catalyst compound and an activator, such as an alumoxane or a non-coordinating anion. The catalyst system may be formed by combining the components thereof with a support structure.

In at least one embodiment, the catalyst compound is represented by Formula (I):

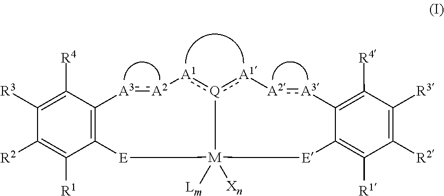

wherein:
   M is a Group 3, 4, 5, or 6 transition metal, or a lanthanide metal (such as Hf, Zr, Ti, Sc, Y, V, Nb, Ta, Db, Cr, Mo, W, Sg or La);
   each of E and E′ is independently O, S, or NR^{A}, where R^{A} is independently hydrogen, C₁-C₄₀ hydrocarbyl, substituted C₁-C₄₀ hydrocarbyl, or a heteroatom-containing group, such as O, such as both E and E′ are O;
   Q is group 14, 15, or 16 atom, such as Q is C, O, S, or N, such as Q is C, N, or O, such as Q is N;
   A¹QA^{1′} is part of a heterocyclic Lewis base containing 4 to 40 non-hydrogen atoms and links A² to A^{2′} via a 3-atom bridge with Q being the central atom of the 3-atom bridge (A¹QA^{1′} combined with the curved line shown joining A¹ and A^{1′} represents the heterocyclic Lewis base);
   each of A¹ and A^{1′} is independently C, N, or C(R^{B}), where R^{B} is selected from hydrogen, C₁-C₂₀ hydrocarbyl, and substituted C₁-C₂₀ hydrocarbyl (for example, each of A¹ and A^{1′} are C);
   [symbol] is a divalent group containing 2 to 40 non-hydrogen atoms and links A¹ to the E-bonded aryl group via a 2-atom bridge, and A³ and A² are combined to form a substituted hydrocarbyl ring, an unsubstituted hydrocarbyl ring, a substituted heterocyclic ring, or an unsubstituted heterocyclic rings each having 5, 6, 7, or 8 ring atoms, and where substitutions on the ring can join to form additional rings, such as A³ and A² are combined to form ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene;
   [symbol] is a divalent group containing 2 to 40 non-hydrogen atoms and links A^{1′} to the E′-bonded aryl group via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic rings each having 5, 6, 7, or 8 ring atoms, and where substitutions on the ring can join to form additional rings, such as A^{3′} and A^{2′} are combined to form, such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene;
   L is a Lewis base;
   X′ is an anionic ligand;
   an X′ group may be joined to an L group to form a monoanionic bidentate group;
   n is 1, 2, or 3;
   m is 0, 1, or 2, where when m is 2, each L is independently a Lewis base and/or each L may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
   n+m is 4 or less; and
   each of R¹, R², R³, R⁴, R¹, R², R^{3′}, and R^{4′} is independently hydrogen, C₁-C₄₀ hydrocarbyl, substituted C₁-C₄₀ hydrocarbyl, a heteroatom or a heteroatom-containing group (such as R^{1′} and R¹ are independently a hydrocarbyl group, such as a tertiary alkyl group, or a cyclic hydrocarbyl group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

The metal, M, is selected from group 3, 4, 5, or 6 elements, such as group 4. For example, the metal, M, is zirconium or hafnium.

The donor atom Q of the neutral heterocyclic Lewis base (in Formula (I)) can be nitrogen, sulfur, or oxygen. In some embodiments, Q is nitrogen.

Non-limiting examples of neutral heterocyclic Lewis base groups include pyridine, pyrazine, pyrimidine, triazine, thiazole, imidazole, thiophene, oxazole, thiazole, furan, and substituted variants of thereof. In some embodiments, heterocyclic Lewis base groups can include pyridine, pyrazine, thiazole, or imidazole.

In some embodiments, each of A¹ and A^{1′} is independently C, N, or C(R⁵), where R⁵ is selected from hydrogen, C₁-C₂₀ hydrocarbyl, and substituted C₁-C₂₀ hydrocarbyl. In some embodiments, each of A¹ and A^{1′} is carbon. When Q is carbon, each of A¹ and A^{1′} can be independently selected from nitrogen and C(R⁵). When Q is nitrogen, each of A¹ and A^{1′} can be carbon. In some embodiments, Q=nitrogen and A¹=A^{1′}=carbon. When Q is nitrogen or oxygen, the heterocyclic Lewis base of Formula (I) might not have any hydrogen atoms bound to the A¹ or A^{1′} atoms, as hydrogens in those positions may undergo unwanted decomposition reactions that reduce the stability of the catalytically active species.

In at least one embodiment of Formula (I), Q is carbon and each of A¹ and A^{1′} is N or C(R⁵), where R⁵ is selected from hydrogen, C₁-C₂₀ hydrocarbyl, substituted C₁-C₂₀ hydrocarbyl, a heteroatom or a heteroatom-containing group. In such embodiments, the A¹QA^{1′} fragment forms part of a cyclic carbene, N-heterocyclic carbene, cyclic amino alkyl carbene, or a substituted variant thereof.

The heterocyclic Lewis base (of Formula (I)) represented by A¹QA^{1′} combined with the curved line joining A¹ and A^{1′} can be selected from the following, with each R⁶ group selected from hydrogen, heteroatoms, C₁-C₂₀ alkyls, C₁-C₂₀ alkoxides, C₁-C₂₀ amides, and substituted C₁-C₂₀ alkyls.

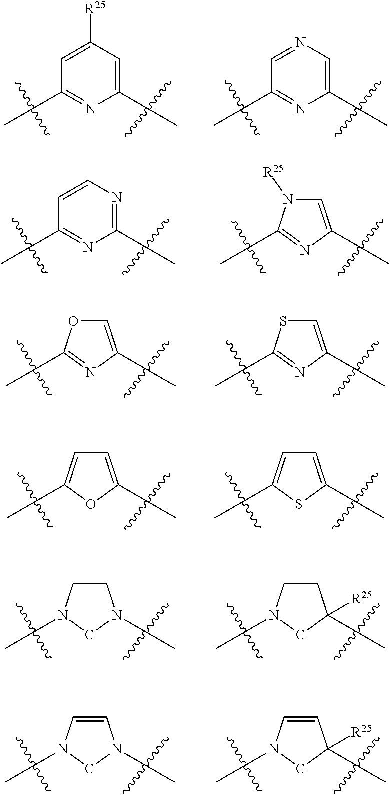

In some embodiments, the heterocyclic Lewis base (of Formula (I)) represented by A¹QA^{1′} combined with the curved line joining A¹ and A^{1′} is a six membered ring containing zero or one ring heteroatoms or a five membered ring containing zero, one two or three ring heteroatoms. Alternately, the heterocyclic Lewis base (of Formula (I)) represented by A¹QA^{1′} combined with the curved line joining A¹ and A^{1′} is not a six membered ring containing two or more ring heteroatoms.

In some embodiments of Formula (I), A¹QA^{1′} is part of a heterocyclic Lewis base containing 2 to 20 non-hydrogen atoms and links A² to A^{2′} via a 3-atom bridge with Q being the central atom of the 3-atom bridge. In some embodiments, each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In some embodiments of Formula (I), M is Hf, Zr, Ti, Sc, Y, or La, Q is nitrogen, both A¹ and A^{1′} are carbon, both E and E′ are oxygen, and both R¹ and R^{1′} are independently C₄-C₂₀ cyclic tertiary alkyl.

In some embodiments of Formula (I), M is Hf, Zr, Ti, Sc, Y, or La, Q is nitrogen, both A¹ and A^{1′} are carbon, both E and E′ are oxygen, and both R¹ and R^{1′} are independently adamantan-1-yl or substituted adamantan-1-yl.

In some embodiments of Formula (I), M is Hf, Zr, Ti, Sc, Y, or La, Q is nitrogen, both A¹ and A^{1′} are carbon, both E and E′ are oxygen, and both R¹ and R^{1′} are independently acyclic tertiary alkyl.

In at least one embodiment, each L of the catalysts represented by Formula (I) can be independently selected from ethers, amines, phosphines, thioethers, esters, Et₂O, MeO^{t}Bu, Et₃N, PhNMe₂, MePh₂N, tetrahydrofuran, or dimethylsulfide. In at least one embodiment, m of the catalysts represented by Formula (I) is 0. In at least one embodiment, each X the catalysts represented by Formula (I) can be independently selected from methyl, benzyl, trimethylsilyl, neopentyl, ethyl, propyl, butyl, phenyl, hydrido, chloro, fluoro, bromo, iodo, trifluoromethanesulfonate, dimethylamido, diethylamido, dipropylamido, or diisopropylamido, such as chloro, such as methyl. In at least one embodiment, n of the catalysts represented by Formula (I) is 2.

In some embodiments, X is selected from methyl, or benzyl, n is 2, and m is zero.

In at least one embodiment, the catalyst compound is represented by Formula (II):

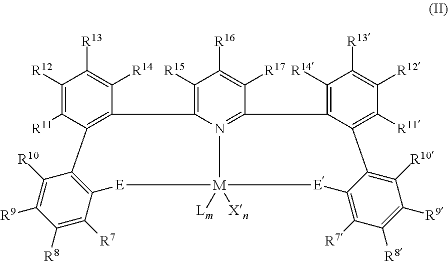

wherein:
   M is a Group 3, 4, 5, or 6 transition metal or a lanthanide metal (such as Hf, Zr, Ti, Sc, Y, or La);
   each of E and E′ is each independently O, S, or NR^{A}, where R^{A} is independently hydrogen, C₁-C₄₀ hydrocarbyl, substituted C₁-C₄₀ hydrocarbyl, or a heteroatom-containing group, such as both E and E′ are O;
   each L is independently a Lewis base;
   each X′ is independently an anionic ligand;
   any two or more L groups may be joined together to form a polydentate (e.g., bidentate) Lewis base;
   an X′ group may be joined to an L group to form a monoanionic bidentate group;
   n is 1, 2, or 3;
   m is 0, 1, or 2;
   n+m is 4 or less;
   each of R⁷, R⁸, R⁹, R¹⁰, R^{7′}, R^{8′}, R^{9′}, and R^{10′} is independently hydrogen, C₁-C₄₀ hydrocarbyl, substituted C₁-C₄₀ hydrocarbyl, a heteroatom or a heteroatom-containing group, or one or more of R⁷ and R⁸, R⁸ and R⁹, R⁹ and R¹⁰, R^{7′} and R^{8′}, R^{8′} and R^{9′}, R^{9′} and R^{10′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
   each of R¹¹, R¹², R¹³, R¹⁴, R^{11′}, R^{12′}, R^{13′}, R^{14′}, R¹⁵, R¹⁶, and R¹⁷ is independently hydrogen, C₁-C₄₀ hydrocarbyl, substituted C₁-C₄₀ hydrocarbyl, a heteroatom or a heteroatom-containing group, or one or more of R¹¹ and R¹², R¹² and R¹³, R¹³ and R¹⁴, R^{11′} and R^{12′}, R^{12′} and R^{13′}, R^{13′} and R^{14′}, R¹⁵ and R¹⁶, or R¹⁶ and R¹⁷ may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In Formula (II), E and E′ are each independently selected from oxygen or NR^{A}, where R^{A} is independently hydrogen, C₁-C₄₀ hydrocarbyl, substituted C₁-C₄₀ hydrocarbyl, or a heteroatom-containing group. In some embodiments, E and E′ are oxygen. When E and/or E′ are NR^{A}, R^{A} can be selected from C₁ to C₂₀ hydrocarbyls, alkyls, or aryls. In one embodiment, E and E′ are each independently selected from O, S, N(alkyl), or N(aryl), where the alkyl can be a C₁ to C₂₀ alkyl, such as methyl, ethyl, propyl, butyl, pentyl, hexyl, octyl, nonyl, decyl, undecyl, dodecyl, and the like, and aryl is a C₆ to C₄₀ aryl group, such as phenyl, naphthalenyl, benzyl, methylphenyl, and the like.

In some embodiments of catalyst compounds of Formula (I) or (II), when E and E′ are oxygen, each phenolate group can be substituted in the position that is next to the oxygen atom (e.g., R¹ and R^{1′} in Formula (I) or R⁷ and R^{7′} in Formula (II)). Thus, when E and E′ are oxygen, each of either R¹ and R^{1′} of Formula (I) or R⁷ and R^{7′} of Formula (II) is independently a C₁-C₄₀ hydrocarbyl, a substituted C₁-C₄₀ hydrocarbyl, a heteroatom, or a heteroatom-containing group, such as each of R¹ and R^{1′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (I) or (II), each of either R¹ and R^{1′} of Formula (I) or R⁷ and R^{7′} of Formula (II) is independently a tertiary hydrocarbyl group. In other embodiments of Formula (I) or (II), each of either R¹ and R^{1′} of Formula (I) or R⁷ and R^{7′} of Formula (II) is independently a (substituted or unsubstituted) cyclic tertiary hydrocarbyl group. In other embodiments of the catalyst compound of Formula (I) or (II), each of either R¹ and R^{1′} of Formula (I) or R⁷ and R^{7′} of Formula (II) is independently a (substituted or unsubstituted) polycyclic tertiary hydrocarbyl group.

In some embodiments of catalyst compounds of Formula (I) or (II), when E and E′ are oxygen, each phenolate group can be substituted in the position that is para to the oxygen atom (e.g., each of either R³ and R^{3′} of Formula (I) or R⁹ and R^{9′} of Formula (II)). Thus, when E and E′ are oxygen, each of either R³ and R^{3′} of Formula (I) or R⁹ and R^{9′} of Formula (II) is independently a C₁-C₄₀ hydrocarbyl, a substituted C₁-C₄₀ hydrocarbyl, a heteroatom, or a heteroatom-containing group, such as each of either R³ and R^{3′} of Formula (I) or R⁹ and R^{9′} of Formula (II) is independently C₁-C₂₀ alkyl, such as methyl, ethyl, propyl, butyl, pentyl, hexyl, heptyl, octyl, nonyl, decyl, or an isomer thereof. Alternatively, each of either R³ and R^{3′} of Formula (I) or R⁹ and R^{9′} of Formula (II) is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (I) or (II), each of either R³ and R^{3′} of Formula (I) or R⁹ and R^{9′} of Formula (II) is independently a (substituted or unsubstituted) C₁-C₂₀ alkyl, such as methyl, ethyl, propyl, butyl, pentyl, hexyl, heptyl, octyl, nonyl, decyl, or isomers thereof. In some embodiments of the catalyst compound of Formula (I) or (II), each of either R³ and R^{3′} of Formula (I) or R⁹ and R^{9′} of Formula (II) is independently a (substituted or unsubstituted) acyclic tertiary hydrocarbyl group. In other embodiments of Formula (I) or (II), each of either R³ and R^{3′} of Formula (I) or R⁹ and R^{9′} of Formula (II) is independently a tert-butyl.

In some embodiments, one or more of R⁷, R⁸, R⁹, R¹⁰, R^{7′}, R^{8′}, R^{9′}, R^{10′}, R¹¹, R¹², R¹³, R¹⁴, R^{11′}, R^{12′}, R^{13′}; R^{14′}, R¹⁵, R¹⁶, or R¹⁷ of Formula (II) are independently hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments of Formula (I) and/or (II), M is Group 4 metal, such as Hf or Zr.

In some embodiments of Formula (I) and/or (II), each of E and E′ is O.

In some embodiments of Formula (I) and/or (II), each of either R¹, R², R³, R⁴, R^{1′}, R^{2′}, R^{3′}, and R^{4′} of Formula (I) or R⁷, R⁸, R⁹, R¹⁰, R^{7′}, R^{8′}, R^{9′}, and R^{10′} of Formula (II) is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of Formula (I) and/or (II), each X′ is, independently, selected from hydrocarbyl radicals having from 1 to 20 carbon atoms (such as alkyls or aryls), hydrides, amides, alkoxides, sulfides, phosphides, halides, alkyl sulfonates, and a combination thereof, such as each X′ is independently selected from halides, aryls, and C₁ to C₈ alkyl groups, such as each X′ is independently a hydrido, dimethylamido, diethylamido, bis(dimethylsilyl)amido, bis(trimethylsilyl) amido, methylenetrimethylsilyl, neopentyl, phenyl, benzyl, methyl, ethyl, propyl, butyl, pentyl, fluoro, iodo, bromo, or chloro group. In some embodiments, each X′ is independently selected from bis(dimethylsilyl)amido, bis(trimethylsilyl) amido, and methylenetrimethylsilyl.

Alternatively, each X′ may be, independently, a halide, a hydride, an alkyl group, or an alkenyl group.

In some embodiments of Formula (I) and/or (II), each L is a Lewis base, independently, selected from ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formula (I) and/or (II), each of either R¹ and R^{1′} of Formula (I) or R⁷ and R^{7′} of Formula (II) is independently cyclic tertiary alkyl groups.

In some embodiments of Formula (I) and/or (II), m is 0, 1 or 2, such as 0.

In some embodiments of Formula (I) and/or (II), each of either R¹ and R^{1′} of Formula (I) or R⁷ and R^{7′} of Formula (II) is not hydrogen.

In some embodiments of Formula (I) and/or (II), each of either R³ and R^{3′} of Formula (I) or R⁹ and R^{9′} of Formula (II) is not hydrogen.

In some embodiments of Formula (I) and (II), M is Zr, Sc, Y, or La, each of E and E′ is O; either R¹ and R^{1′} of Formula (I) or R⁷ and R^{7′} of Formula (II) is independently a C₁-C₄₀ hydrocarbyl, a substituted C₁-C₄₀ hydrocarbyl, a heteroatom or a heteroatom-containing group, and each of either R², R³, R⁴, R^{2′}, R^{3′}, and R^{4′} of Formula (II) or R⁸, R⁹, R¹⁰, R^{8′}, R^{9′}, and R^{10′} of Formula (II) is independently hydrogen, C₁-C₂₀ hydrocarbyl, or substituted C₁-C₂₀ hydrocarbyl.

In some embodiments of Formula (II), each of R¹¹, R¹², R¹³, R¹⁴, R^{11′}, R^{12′}, R^{13′}, R^{14′}, R¹⁵, R¹⁶, and R¹⁷ is independently hydrogen, methyl, ethyl, propyl, butyl, pentyl, hexyl, or an isomer thereof.

In some embodiments of Formula (II), each of R¹¹, R¹², R¹³, R¹⁴, R^{11′}, R^{12′}, R^{13′}, R^{14′}, R¹⁵, R¹⁶, and R¹⁷ is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (II), M is Hf or Zr, each of E and E′ is O; each of R⁷ and R^{7′} is independently a C₁-C₄₀ hydrocarbyl, a substituted C₁-C₄₀ hydrocarbyl, a heteroatom or a heteroatom-containing group; each of R⁹ and R^{9′} is independently a C₁-C₄₀ hydrocarbyl, a substituted C₁-C₄₀ hydrocarbyl, a heteroatom or a heteroatom-containing group; each of R⁷, R⁸, R⁹, R^{7′}, R^{8′}, and R^{9′} is independently hydrogen, C₁-C₂₀ hydrocarbyl, substituted C₁-C₂₀ hydrocarbyl, a heteroatom or a heteroatom-containing group, or one or more of R⁷ and R⁸, R⁸ and R⁹, R⁹ and R¹⁰, R^{7′} and R^{8′}, R^{8′} and R^{9′}, R^{9′} and R^{10′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; each X′ is independently selected from substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system); n is 2; m is 0; and each of R¹¹, R¹², R¹³, R¹⁴, R^{11′}, R^{12′}, R^{13′}, R^{14′}, R¹⁵, R¹⁶, and R¹⁷ is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R¹¹, R¹², R¹³, R¹⁴, R^{11′}, R^{12′}, R^{13′}, R^{14′}, R¹⁵, R¹⁶, and R¹⁷ is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (II), M is Hf or Zr, both E and E′ are oxygen, both R⁷ and R^{7′} are independently C₄-C₂₀ cyclic tertiary alkyl, and both R⁹ and R^{9′} are independently C₁-C₁₀ alkyl.

In some embodiments of Formula (II), M is Hf or Zr, both E and E′ are oxygen, both R⁷ and R^{7′} are adamantan-1-yl or substituted adamantan-1-yl, and both R⁹ and R^{9′} are independently C₁-C₁₀ alkyl.

In some embodiments of Formula (II), M is Hf or Zr, both E and E′ are oxygen, and each of R⁷, R^{7′}, R⁹ and R^{9′} are independently adamantan-1-yl or substituted adamantan-1-yl.

In some embodiments, each of Formula (I) or Formula (II) are represented by

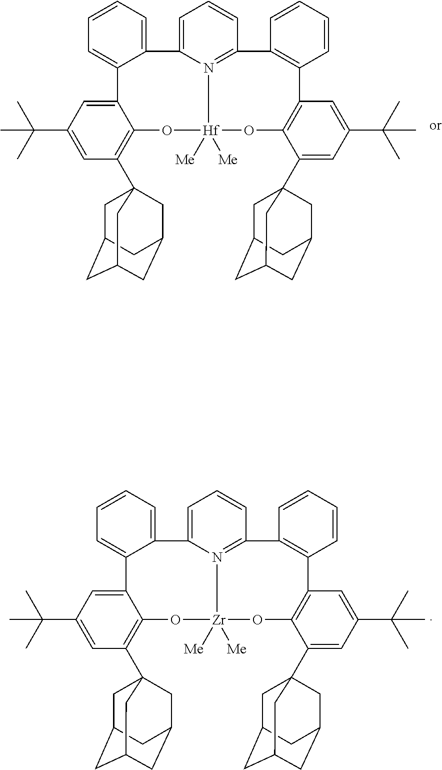

In at least one embodiment, the catalyst compound is represented by Formula (III):

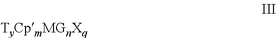

wherein:
   Cp′ is a tetrahydroindacenyl group (such as tetrahydro-s-indacenyl or tetrahydro-as-indacenyl) which is optionally substituted or unsubstituted, provided that when Cp′ is tetrahydro-s-indacenyl: 1) the 3 and/or 4 positions are not aryl or substituted aryl, 2) the 3 position is not directly bonded to a group 15 or 16 heteroatom, 3) there are no additional rings fused to the tetrahydroindacenyl ligand, 4) T is not bonded to the 2-position, and 5) the 5, 6, or 7-position (such as the 6 position) is geminally disubstituted, such as with two C₁-C₁₀ alkyl groups;
   M is a group 3, 4, 5, or 6 transition metal, such as group 4 transition metal, for example titanium, zirconium, or hafnium (such as titanium);
   G is a heteroatom group represented by the formula JRⁱ_{z} where J is N, P, O or S, Rⁱ is a C₁ to C₁₀₀ hydrocarbyl group (such as a C₁ to C₂₀ hydrocarbyl group), and z is 2 when J is N or P, and z is 1 when J is O or S (such as J is N and z is 1) (Rⁱ can be a linear, branched or cyclic C₁ to C₂₀ hydrocarbyl group, such as independently selected from methyl, ethyl, propyl, butyl, pentyl, hexyl, heptyl, octyl, nonyl, decyl, and isomers thereof, including t-butyl, cyclododecyl, cyclooctyl, such as t-butyl and or cyclododecyl.);
   T is a bridging group (such as dialkylsilylene or dialkylcarbylene). T is such as (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl and R⁸ and R⁹ may optionally be bonded together to form a ring structure, and in a particular embodiment, R⁸ and R⁹ are not aryl);
   y is 0 or 1, indicating the absence or presence of T;
   X is a leaving group (such as a halide, a hydride, an alkyl group, an alkenyl group or an arylalkyl group);
   m=1; n=1, 2 or 3; q=1, 2 or 3; and the sum of m+n+q is equal to the oxidation state of the transition metal (such as 3, 4, 5, or 6, such as 4); such as m=1, n=1, q is 2, and y=1.

In at least one embodiment of Formula (III), M is a Group 4 transition metal (such as Hf, Ti and/or Zr, such as Ti). In at least one embodiment of Formula (I), JRⁱz is cyclododecyl amido, t-butyl amido, and or 1-adamantyl amido.

In at least one embodiment of Formula (III), each X is, independently, selected from hydrocarbyl radicals having from 1 to 20 carbon atoms, aryls, hydrides, amides, alkoxides, sulfides, phosphides, halides, dienes, amines, phosphines, ethers, and a combination thereof, (two X's may form a part of a fused ring or a ring system), such as each X is independently selected from halides, aryls and C₁ to C₅ alkyl groups, such as each X is a phenyl, methyl, ethyl, propyl, butyl, pentyl, or chloro group.

In at least one embodiment of Formula (III), the Cp′ group may be substituted with a combination of substituent groups R. R includes one or more of hydrogen, or linear, branched alkyl radicals, or alkenyl radicals, alkynyl radicals, cycloalkyl radicals or aryl radicals, acyl radicals, alkoxy radicals, aryloxy radicals, alkylthio radicals, dialkylamino radicals, alkoxycarbonyl radicals, aryloxycarbonyl radicals, carbamoyl radicals, alkyl- or dialkyl-carbamoyl radicals, acyloxy radicals, acylamino radicals, aroylamino radicals, straight, branched or cyclic, alkylene radicals, or combination thereof. In at least one embodiment, substituent groups R have up to 50 non-hydrogen atoms, such as from 1 to 30 carbon, that can also be substituted with halogens or heteroatoms or the like, provided that when Cp′ is tetrahydro-s-indacenyl: 1) the 3 and/or 4 position is not aryl or substituted aryl, 2) the 3-position is not substituted with a group 15 or 16 heteroatom, 3) there are no additional rings fused to the tetrahydroindacenyl ligand, T is not bonded to the 2-position, and 5) the 5, 6, or 7-position (such as the 6 position) is geminally di-substituted, such as with two C₁-C₁₀ alkyl groups. Non-limiting examples of alkyl substituents R include methyl, ethyl, propyl, butyl, pentyl, hexyl, cyclopentyl, cyclohexyl, benzyl or phenyl groups and the like, including all their isomers, for example, tertiary butyl, isopropyl and the like. Other hydrocarbyl radicals include fluoromethyl, fluoroethyl, difluoroethyl, iodopropyl, bromohexyl chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)-silyl, methylbis(difluoromethyl) silyl, bromomethyldimethylgermyl and the like; and disubstituted boron radicals including dimethylboron for example; and disubstituted pnictogen radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen substituents R include the atoms carbon, silicon, boron, aluminum, nitrogen, phosphorus, oxygen, tin, sulfur, germanium and the like, including olefins such as, but not limited to, olefinically unsaturated substituents including vinyl-terminated ligands, for example but-3-enyl, prop-2-enyl, hex-5-enyl and the like.

In at least one embodiment of Formula (III), each of the substituents R is, independently, hydrocarbyl groups, heteroatoms, or heteroatom containing groups, such as methyl, ethyl, propyl, butyl, pentyl, hexyl, heptyl, octyl, nonyl, decyl, undecyl, dodecyl or an isomer thereof, or a C₁ to C₂₀ hydrocarbyl substituted with an N, O, S and or P heteroatom or heteroatom containing group (typically having up to 12 atoms, including the N, O, S and P heteroatoms), provided that when Cp′ is tetrahydro-s-indacenyl, the 3 and/or 4 position are not aryl or substituted aryl, the 3 position is not substituted with a group 15 or 16 heteroatom, and there are no additional rings fused to the tetrahydroindacenyl ligand, T is not bonded to the 2-position, and the 5, 6, or 7-position (such as the 6 position) is geminally di-substituted, such as with two C₁-C₁₀ alkyl groups.

In at least one embodiment of Formula (I), the Cp′ group is tetrahydro-as-indacenyl or tetrahydro-s-indacenyl which may be substituted.

y can be 1 where T is a bridging group containing at least one Group 13, 14, 15, or 16 element, in particular boron or a Group 14, 15 or 16 element. Examples of suitable bridging groups include P(═S)R*, P(═Se)R*, P(═O)R*, R*₂C, R*₂Si, R*₂Ge, R*₂CCR*₂, R*₂CCR*₂CR*₂, R*₂CCR*₂CR*₂CR*₂, R*C═CR*, R*C═CR*CR*₂, R*₂CCR*═CR*CR*₂, R*C═CR*CR*═CR*, R*C═CR*CR*₂CR*₂, R*₂CSiR*₂, R*₂SiSiR*₂, R*₂SiOSiR*₂, R*₂CSiR*₂CR*₂, R*₂SiCR*₂SiR*₂, R*C═CR*SiR*₂, R*₂CGeR*₂, R*₂GeGeR*₂, R*₂CGeR*₂CR*₂, R*₂GeCR*₂GeR*₂, R*₂SiGeR*₂, R*C═CR*GeR*₂, R*B, R*₂C—BR*, R*₂C—BR*—CR*₂, R*₂C—O—CR*₂, R*₂CR*₂C—O—CR*₂CR*₂, R*₂C—O—CR*₂CR*₂, R*₂C—O—CR*═CR*, R*₂C—S—CR*₂, R*₂CR*₂C—S—CR*₂CR*₂, R*₂C—S—CR*₂CR*₂, R*₂C—S—CR*═CR*, R*₂C—Se—CR*₂, R*₂CR*₂C—Se—CR*₂CR*₂, R*₂C—Se—CR*₂CR*₂, R*₂C—Se—CR*═CR*, R*₂C—N═CR*, R*₂C—NR*—CR*₂, R*₂C—NR*—CR*₂CR*₂, R*₂C—NR*—CR*═CR*, R*₂CR*₂C—NR*—CR*₂CR*₂, R*₂C—P═CR*, R*₂C—PR*—CR*₂, O, S, Se, Te, NR*, PR*, AsR*, SbR*, O—O, S—S, R*N—NR*, R*P—PR*, O—S, O—NR*, O—PR*, S—NR*, S—PR*, and R*N—PR* where R* is hydrogen or a C₁-C₂₀ containing hydrocarbyl, substituted hydrocarbyl, halocarbyl, substituted halocarbyl, silylcarbyl or germylcarbyl substituent and optionally two or more adjacent R* may join to form a substituted or unsubstituted, saturated, partially unsaturated or aromatic, cyclic or polycyclic substituent. Examples for the bridging group T include —CH₂—, —CH₂CH₂—, —SiMe₂-, —SiPh₂-, —Si(Me)(Ph)-, —Si(CH₂)₃—, —Si(CH₂)₄—, —O—, —S—, —N(Ph)-, —P(Ph)-, —N(Me)-, —P(Me)-, —N(Et)-, —N(Pr)—, —N(Bu)-, —P(Et)-, —P(Pr)—, (Me)₂SiOSi(Me)₂-, and —P(Bu)-. In an embodiment of the present disclosure, when Cp′ is tetrahydro-s-indacenyl and T is R*₂Si, then R* is not aryl. In some embodiments, R* is not aryl or substituted aryl.

In some embodiments, Formula (III) is represented by:

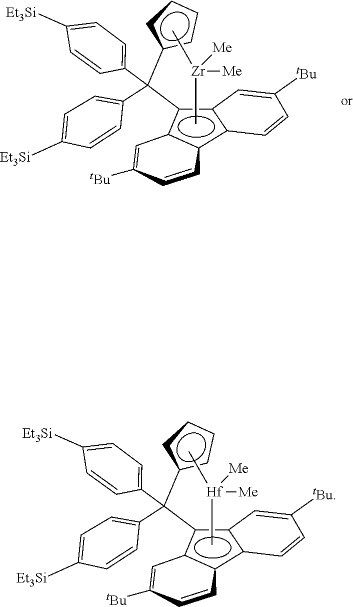

The catalyst compound can be represented by the Formula (IV):

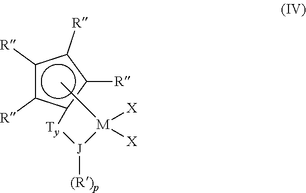

where M is a group 4 metal (such as Hf, Ti or Zr, such as in some examples, M is Ti);
J is N, O, S or P (such as N and p=1);
p is 1 when J is N or P, and is 0 when J is O or S (such as in some examples, N=1 and p=1);
R″ is hydrogen;
T is (CR⁸R⁹)ₓ, SiR⁸R⁹ or GeR⁸R⁹ where x is 1 or 2, R⁸ and R⁹ are independently selected from hydrogen or substituted or unsubstituted hydrocarbyl, halocarbyl, silylcarbyl and germylcarbyl and R⁸ and R⁹ may optionally be bonded together to form a ring structure;
each X is, independently, a leaving group, or two Xs are joined and bound to the metal atom to form a metallocycle ring, or two Xs are joined to form a chelating ligand, a diene ligand, or an alkylidene;
y is 0 or 1; and
R′ is a C₁-C₁₀₀ substituted or unsubstituted hydrocarbyl, halocarbyl, silylcarbyl, substituted hydrocarbyl rings, unsubstituted hydrocarbyl rings, substituted heterocyclic rings, or unsubstituted heterocyclic rings each having 5, 6, 7, or 8 ring atoms, such as R′ is a methyl, ethyl, propyl, butyl, pentyl, hexyl, heptyl, octyl, nonyl, decyl, undecyl, dodecyl or an isomer thereof, such as R′ is t-butyl, neopentyl, cyclohexyl, cyclooctyl, cyclododecyl, adamantyl, or norbornyl, p is an integer of greater than 1.

In some embodiments, Formula (IV) is represented by:

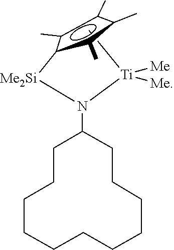

The catalyst compound can be one or more bridged mono-tetrahydro-s-indacenyl transition metal compounds represented by the Formula (V):

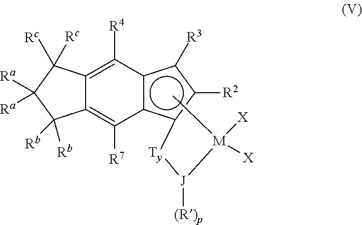

where M is a group 4 metal (such as Hf, Ti or Zr, such as Ti);
J is N, O, S or P (such as N and p=1);
p is 1 when J is N or P, and is 0 when J is O or S (such as N=1 and p=1);
each R², R³, R⁴, and R⁷ is independently hydrogen, or a C₁-C₅₀ substituted or unsubstituted hydrocarbyl, halocarbyl, silylcarbyl or germylcarbyl, provided that: 1) R³ and/or R⁴ are not aryl or substituted aryl, 2) R³ is not directly bonded to a group 15 or 16 heteroatom, and 3) adjacent R⁴, R^{c}, R^{a} or R⁷ do not join together to form a fused ring system; each R′ is, independently, a C₁-C₁₀₀ substituted or unsubstituted hydrocarbyl, halocarbyl, silylcarbyl or germylcarbyl;

T is (CR⁸R⁹)ₓ, SiR⁸R⁹ or GeR⁸R⁹ where x is 1 or 2, R⁸ and R⁹ are independently selected from hydrogen or substituted or unsubstituted hydrocarbyl, halocarbyl, silylcarbyl and germylcarbyl and R⁸ and R⁹ may optionally be bonded together to form a ring structure; each X is, independently, a leaving group or C₁-C₁₀₀ alkyl, or two Xs are joined and bound to the metal atom to form a metallocycle ring, or two Xs are joined to form a chelating ligand, a diene ligand, or an alkylidene; 20
R′ is a C₁-C₁₀₀ substituted or unsubstituted hydrocarbyl, halocarbyl, silylcarbyl, substituted hydrocarbyl rings, unsubstituted hydrocarbyl rings, substituted heterocyclic rings, or unsubstituted heterocyclic rings each having 5, 6, 7, or 8 ring atoms, such as R′ is a methyl, ethyl, propyl, butyl, pentyl, hexyl, heptyl, octyl, nonyl, decyl, undecyl, dodecyl or an isomer thereof, such as R′ is t-butyl, neopentyl, cyclohexyl, cyclooctyl, cyclododecyl, adamantyl, or norbornyl, p is an integer of greater than 1;
each R^{a}, R^{b}, and R^{c} is independently C₁-C₁₀ alkyl, or hydrogen, provided that both R^{a}, both R^{b}, or both R^{c} are not hydrogen. In at least one embodiment, R^{a} is independently selected from hydrogen, methyl, ethyl, propyl, butyl, pentyl, hexyl, heptyl, octyl, nonyl, decyl, and isomers thereof, such as hydrogen or methyl. In at least one embodiment, each of R^{a} is C₁-C₁₀ alkyl.

In some embodiments, Formula (V) is represented by

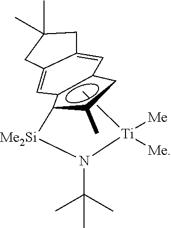

The catalyst compound can be one or more bridged mono-tetrahydro-as-indacenyl transition metal compounds represented by the Formula (VI):

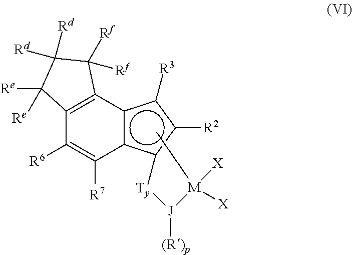

where M is a group 4 metal (such as Hf, Ti or Zr, such as Ti);
J is N, O, S or P (such as N and p=1);
p is 1 when J is N or P, and is 0 when J is O or S (such as N=1 and p=1);
R² and R³ is independently hydrogen, or a C₁-C₅₀ substituted or unsubstituted hydrocarbyl, halocarbyl, silylcarbyl or germylcarbyl, provided that: 1) R³ is not aryl or substituted aryl, 2) R³ is not directly bonded to a group 15 or 16 heteroatom, and 3) adjacent R^{c}, R⁶ or R⁷ do not join together to form a fused ring system;
R⁶ and R⁷ may optionally be bonded together to form a ring structure including one or more substituted hydrocarbyl rings, unsubstituted hydrocarbyl rings, substituted heterocyclic rings, or unsubstituted heterocyclic rings each having 5, 6, 7, or 8 ring atoms;
T is (CR⁸R⁹)ₓ, SiR⁸R⁹ or GeR⁸R⁹ where x is 1 or 2, R⁸ and R⁹ are independently selected from hydrogen or substituted or unsubstituted hydrocarbyl, halocarbyl, silylcarbyl and germylcarbyl and R⁸ and R⁹ may optionally be bonded together to form a ring structure;
each X is, independently, a leaving group, or two Xs are joined and bound to the metal atom to form a metallocycle ring, or two Xs are joined to form a chelating ligand, a diene ligand, or an alkylidene;
each R^{d}, R^{e}, and R^{f} is independently C₁-C₁₀ alkyl, or hydrogen, provided that both R^{d}, both R^{e}, or both R^{f} are not hydrogen. In at least one embodiment, R^{d} is independently selected from hydrogen, methyl, ethyl, propyl, butyl, pentyl, hexyl, heptyl, octyl, nonyl, decyl, and isomers thereof, such as hydrogen or methyl. In at least one embodiment, each of R^{d} is C₁-C₁₀ alkyl.
R′ is a C₁-C₁₀₀ substituted or unsubstituted hydrocarbyl, halocarbyl, silylcarbyl, substituted hydrocarbyl rings, unsubstituted hydrocarbyl rings, substituted heterocyclic rings, or unsubstituted heterocyclic rings each having 5, 6, 7, or 8 ring atoms, such as R′ is a methyl, ethyl, propyl, butyl, pentyl, hexyl, heptyl, octyl, nonyl, decyl, undecyl, dodecyl or an isomer thereof, such as R′ is t-butyl, neopentyl, cyclohexyl, cyclooctyl, cyclododecyl, adamantyl, or norbornyl, p is an integer of greater than 1.

In some embodiments, each of Formula (VI) is represented by

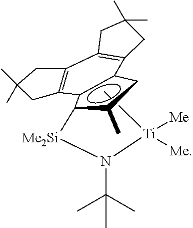

The catalyst compound can be represented by the Formula (VII):

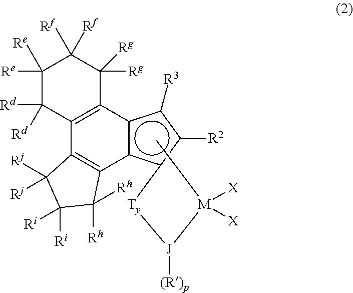

where M is a group 4 metal (such as Hf, Ti or Zr, such as Ti);
J is N, O, S or P (such as N and p=1);
p is 1 when J is N or P, and is 0 when J is O or S (such as N=1 and p=1);
R² and R³ is independently hydrogen, or a C₁-C₅₀ substituted or unsubstituted hydrocarbyl, halocarbyl, silylcarbyl or germylcarbyl, provided that: 1) R³ is not aryl or substituted aryl, 2) R³ is not directly bonded to a group 15 or 16 heteroatom, and 3) adjacent R^{d}, R^{j}, R^{g} or R³ do not join together to form a fused ring system;
each R^{d}, R^{e}, R^{f}, R^{g}, Rⁱ, and R^{j} is independently C₁-C₁₀ alkyl, or hydrogen. In at least one embodiment, Rⁱ is independently selected from hydrogen, methyl, ethyl, propyl, butyl, pentyl, hexyl, heptyl, octyl, nonyl, decyl, and isomers thereof, such as hydrogen or methyl. In at least one embodiment, each of R^{d} is C₁-C₁₀ alkyl.

In at least one embodiment of the present disclosure, each R², R³, R⁶, and R⁷ is independently hydrogen, or a C₁-C₅₀ substituted or unsubstituted hydrocarbyl, halocarbyl, silylcarbyl or germylcarbyl, such as methyl, ethyl, propyl, butyl, pentyl, hexyl, heptyl, octyl, nonyl, decyl, undecyl, and dodecyl or an isomer thereof.

In at least one embodiment of the present disclosure, each R², R³, R⁴, and R⁷ is independently hydrogen, or a C₁-C₅₀ substituted or unsubstituted hydrocarbyl, halocarbyl, silylcarbyl or germylcarbyl, such as methyl, ethyl, propyl, butyl, pentyl, hexyl, heptyl, octyl, nonyl, decyl, undecyl, and dodecyl or an isomer thereof.

In at least one embodiment of the present disclosure, each R^{a} or R^{d} is independently selected from methyl, ethyl, propyl, butyl, pentyl, hexyl, heptyl, octyl, nonyl, decyl, and isomers thereof, such as methyl and ethyl, such as methyl.

In at least one embodiment of the present disclosure, each R^{b}, R^{c}, R^{e} or R^{f} is independently selected from methyl, ethyl, propyl, butyl, pentyl, hexyl, heptyl, octyl, nonyl, decyl, and isomers thereof, such as hydrogen or methyl.

Alternatively, in an embodiment, the indacene ligand does not have a methyl at the 6 position, and one or both of R^{a} is not methyl.

In at least one embodiment of the present disclosure, R^{b} is independently selected from hydrogen, methyl, ethyl, propyl, butyl, pentyl, hexyl, heptyl, octyl, nonyl, decyl, and isomers thereof, such as methyl and ethyl, such as methyl.

In at least one embodiment of the present disclosure, R^{c} is independently selected from hydrogen, methyl, ethyl, propyl, butyl, pentyl, hexyl, heptyl, octyl, nonyl, decyl, and isomers thereof, such as hydrogen or methyl.

In at least one embodiment of the present disclosure, R′ is a C₁-C₁₀₀ substituted or unsubstituted hydrocarbyl, halocarbyl, or silylcarbyl, such as methyl, ethyl, propyl, butyl, pentyl, hexyl, heptyl, octyl, nonyl, decyl, undecyl, dodecyl or an isomer thereof, such as t-butyl, neopentyl, cyclohexyl, cyclooctyl, cyclododecyl, adamantyl, or norbornyl.

In at least one embodiment of the present disclosure, T is CR⁸R⁹, R⁸R⁹C—CR⁸R⁹, SiR⁸R⁹ or GeR⁸R⁹ where R⁸ and R⁹ are independently selected from substituted or unsubstituted hydrocarbyl, halocarbyl, silylcarbyl and R⁸ and R⁹ may optionally be bonded together to form a ring structure, such as each R⁸ and R⁹ is independently methyl, ethyl, propyl, butyl, pentyl, hexyl, heptyl, octyl, nonyl, decyl, benzyl, phenyl, methylphenyl or an isomer thereof, such as methyl, ethyl, propyl, butyl, or hexyl.

In at least one embodiment of the present disclosure, at least one of R⁸ or R⁹ is not aryl. In at least one embodiment of the present disclosure, R⁸ is not aryl. In at least one embodiment of the present disclosure, R⁹ is not aryl. In at least one embodiment of the present disclosure, R⁸ and R⁹ are not aryl.

In at least one embodiment of the present disclosure, R⁸ and R⁹ are independently C₁-C₁₀ alkyl, such as methyl, ethyl, propyl, butyl, pentyl, hexyl, heptyl, octyl, nonyl, decyl, or an isomer thereof.

In at least one embodiment of the present disclosure, each R², R³, R⁴, and R⁷ is independently hydrogen or hydrocarbyl. Each R², R³, R⁴, and R⁷ can be independently hydrogen or a C₁-C₁₀ alkyl, such as methyl, ethyl, propyl, butyl, pentyl, hexyl, heptyl, octyl, nonyl, decyl, or an isomer thereof.

In at least one embodiment of the present disclosure, each R², R³, R⁶, and R⁷ is independently hydrogen or hydrocarbyl. Each R², R³, R⁶, and R⁷ can be independently hydrogen or a C₁-C₁₀ alkyl, such as methyl, ethyl, propyl, butyl, pentyl, hexyl, heptyl, octyl, nonyl, decyl, or an isomer thereof.

In at least one embodiment of the present disclosure, R² is a C₁-C₁₀ alkyl and R³, R⁴, and R⁶ are hydrogen. In at least one embodiment of the present disclosure, R² is a C₁-C₁₀ alkyl and R³, R⁶, and R⁷ are hydrogen.

In at least one embodiment of the present disclosure, R², R³, R⁴, and R⁶ are hydrogen. In at least one embodiment of the present disclosure, R², R³, R⁶, and R⁷ are hydrogen.

In at least one embodiment of the present disclosure, R² is methyl, ethyl, or an isomer of propyl, butyl, pentyl or hexyl, and R³, R⁴, and R⁷ are hydrogen. In at least one embodiment of the present disclosure, R² is methyl, ethyl, or an isomer of propyl, butyl, pentyl or hexyl, and R³, R⁶, and R⁷ are hydrogen.

In at least one embodiment of the present disclosure, R² is methyl and R³, R⁴, and R⁷ are hydrogen. In at least one embodiment of the present disclosure, R² is methyl and R³, R⁶, and R⁷ are hydrogen.

In at least one embodiment of the present disclosure, R³ is hydrogen. In at least one embodiment of the present disclosure, R² is hydrogen.

In at least one embodiment of the present disclosure, R² and each R^{a} is independently a C₁-C₁₀ alkyl and R³, R⁴, R⁶ and each R^{b} and R^{c} are hydrogen.

In at least one embodiment of the present disclosure, R² and each R^{d} is a C₁-C₁₀ alkyl and R³, R⁶, R⁷ and each R^{e} and R^{f} are hydrogen.

In at least one embodiment of the present disclosure, R² and each R^{a} is independently a methyl, ethyl, propyl, butyl, pentyl, hexyl, heptyl, octyl, nonyl, decyl, or an isomer thereof, and R³, R⁴, R⁶ and each R^{b} and R^{c} are hydrogen.

In at least one embodiment of the present disclosure, R² and each R^{d} is a methyl, ethyl, propyl, butyl, pentyl, hexyl, heptyl, octyl, nonyl, decyl, or an isomer thereof, and R³, R⁶, R⁷ and each R^{e} and R^{f} are hydrogen.

In at least one embodiment of the present disclosure, R′ is C₁-C₁₀₀ or C₁-C₃₀ substituted or unsubstituted hydrocarbyl.

In at least one embodiment of the present disclosure, R′ is C₁-C₃₀ substituted or unsubstituted alkyl (linear, branched, or cyclic), aryl, alkaryl, or heterocyclic group. In at least one embodiment of the present disclosure, R′ is C₁-C₃₀ linear, branched or cyclic alkyl group.

In at least one embodiment of the present disclosure, R′ is methyl, ethyl, or any isomer of propyl, butyl, pentyl, hexyl, heptyl, octyl, nonyl, decyl, undecyl, or dodecyl. In at least one embodiment of the present disclosure, R′ is a cyclic or polycyclic hydrocarbyl.

In at least one embodiment of the present disclosure, R′ is selected from tert-butyl, neopentyl, cyclohexyl, cycloheptyl, cyclooctyl, cyclononyl, cyclodecyl, cycloundecyl, cyclododecyl, adamantyl, and norbornyl. In at least one embodiment, R′ is tert-butyl.

In at least one embodiment of the present disclosure, Rⁱ is selected from tert-butyl, neopentyl, cyclohexyl, cycloheptyl, cyclooctyl, cyclononyl, cyclodecyl, cycloundecyl, cyclododecyl, adamantyl, and norbornyl. In at least one embodiment, Rⁱ is tert-butyl.

In at least one embodiment of the present disclosure, T is selected from diphenylmethylene, dimethylmethylene, 1,2-ethylene, cyclotrimethylenesilylene, cyclotetramethylenesilylene, cyclopentamethylenesilylene, dimethylsilylene, diethylsilylene, methylethylsilylene, and dipropylsilylene.

In at least one embodiment of the present disclosure, each R^{a} is independently methyl, ethyl, propyl, butyl, pentyl or hexyl. In at least one embodiment of the present disclosure, each R^{a} is independently methyl or ethyl. Each R^{a} can be methyl.

In at least one embodiment of the present disclosure, each R^{d} is independently methyl, ethyl, propyl, butyl, pentyl or hexyl. In at least one embodiment of the present disclosure, each R^{d} is independently methyl or ethyl. Each R^{d} can be methyl.

In at least one embodiment of the present disclosure, each R^{d} and each R^{e} and R^{f} are independently hydrogen, methyl, ethyl, propyl, butyl, pentyl or hexyl. In at least one embodiment of the present disclosure, each R^{d} is independently hydrogen, methyl, or ethyl.

In at least one embodiment of the present disclosure, each R^{b} and R^{c} is hydrogen. In at least one embodiment of the present disclosure, each R^{e} and R^{f} is hydrogen.

In at least one embodiment of the present disclosure, each X is hydrocarbyl, halocarbyl, or substituted hydrocarbyl or halocarbyl.

In at least one embodiment of the present disclosure, X is methyl, benzyl, or halo where halo includes fluoro, chloro, bromo and iodido.

In at least one embodiment of Formula (IV) or (V) of the present disclosure: 1) R³ and/or R⁴ are not aryl or substituted aryl, 2) R³ is not directly bonded to a group 15 or 16 heteroatom, and 3) adjacent R⁴, R^{c}, R^{a} or R⁷ do not join together to form a fused ring system, and 4) each R^{a} is a C₁ to C₁₀ alkyl (such as methyl, ethyl, propyl, butyl, pentyl, hexyl, heptyl, octyl, nonyl, decyl, or an isomer thereof).

In an embodiment of the present disclosure, T of Formulas (IV) or (V) is represented by the Formula ER^{d}₂ or (ER^{d}₂)₂, where E is C, Si, or Ge, and each R^{d} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{d} can form a cyclic structure including aromatic, partially saturated, or saturated cyclic or fused ring system. In an embodiment, T is a bridging group comprising carbon or silica, such as dialkylsilyl, such as T is selected from —CH₂—, —CH₂CH₂—, —C(CH₃)₂—, —Si(Me)₂-, cyclotrimethylenesilylene (—Si(CH₂)₃—), cyclopentamethylenesilylene (—Si(CH₂)₅—) and cyclotetramethylenesilylene (—Si(CH₂)₄—).

In some embodiments, R^{d} is not aryl or substituted aryl.

In at least one embodiment, a catalyst compound is one or more of: dimethylsilylene(2,6,6-trimethyl-1,5,6,7-tetrahydro-s-indacen-1-yl)(cyclododecylamido)M(R)₂; dimethylsilylene(2,6,6-trimethyl-1,5,6,7-tetrahydro-s-indacen-1-yl)(t-butylamido)M(R)₂; dimethylsilylene(6,6-dimethyl-1,5,6,7-tetrahydro-s-indacen-1 yl)(cyclododecylamido)M(R)₂; dimethylsilylene(6,6-dimethyl-1,5,6,7-tetrahydro-s-indacen-1-yl)(t-butylamido)M(R)₂; dimethylsilylene(2,7,7-trimethyl-3,6,7,8-tetrahydro-as-indacen-3-yl)(cyclododecylamido)M(R)₂; dimethylsilylene(2,7,7-trimethyl-3,6,7,8-tetrahydro-as-indacen-3-yl)(t-butylamido)M(R)₂; dimethylsilylene(7,7-dimethyl-3,6,7,8-tetrahydro-as-indacen-3-yl)(cyclododecylamido)M(R)₂; dimethylsilylene(7,7-dimethyl-3,6,7,8-tetrahydro-as-indacen-3-yl)(t-butylamido)M(R)₂; μ-(CH₃)₂Si(2,6,6-trimethyl-1,5,6,7-tetrahydro-s-indacen-1-yl)(1-adamantylamido)M(R)₂; μ-(CH₃)₂Si(6,6-dimethyl-1,5,6,7-tetrahydro-s-indacen-1-yl)(1-adamantylamido)M(R)₂; μ-(CH₃)₂Si(2-methyl-6,6-diethyl-1,5,6,7-tetrahydro-s-indacen-1-yl)(1-adamantylamido)M(R)₂; μ-(CH₃)₂Si(6,6-diethyl-1,5,6,7-tetrahydro-s-indacen-1-yl)(1-adamantylamido)M(R)₂; μ-(CH₃)₂Si(2,7,7-trimethyl-3,6,7,8-tetrahydro-as-indacen-3-yl)(1-adamantylamido)M(R)₂; μ-(CH₃)₂Si(7,7-dimethyl-3,6,7,8-tetrahydro-as-indacen-3-yl)(1-adamantylamido)M(R)₂; μ-(CH₃)₂Si(2-methyl-3,6,7,8-tetrahydro-as-indacen-3-yl)(1-adamantylamido)M(R)₂; μ-(CH₃)₂Si(2-methyl-7,7-diethyl-3,6,7,8-tetrahydro-as-indacen-3-yl)(1-adamantylamido)M(R)₂; μ-(CH₃)₂Si(7,7-diethyl-3,6,7,8-tetrahydro-as-indacen-3-yl)(1-adamantylamido)M(R)₂; μ-(CH₃)₂Si(2,6,6-trimethyl-1,5,6,7-tetrahydro-s-indacen-1-yl)(t-butylamido)M(R)₂; μ-(CH₃)₂Si(6,6-dimethyl-1,5,6,7-tetrahydro-s-indacen-1-yl)(t-butylamido)M(R)₂; μ-(CH₃)₂Si(2-methyl-6,6-diethyl-1,5,6,7-tetrahydro-s-indacen-1-yl)(t-butylamido)M(R)₂; μ-(CH₃)₂Si(6,6-diethyl-1,5,6,7-tetrahydro-s-indacen-1-yl)(t-butylamido)M(R)₂; μ-(CH₃)₂Si(2,7,7-trimethyl-3,6,7,8-tetrahydro-as-indacen-3-yl)(t-butylamido)M(R)₂; μ-(CH₃)₂Si(7,7-dimethyl-3,6,7,8-tetrahydro-as-indacen-3-yl)(t-butylamido)M(R)₂; μ-(CH₃)₂Si(2-methyl-3,6,7,8-tetrahydro-as-indacen-3-yl)(t-butylamido)M(R)₂; μ-(CH₃)₂Si(2-methyl-7,7-diethyl-3,6,7,8-tetrahydro-as-indacen-3-yl)(t-butylamido)M(R)₂; μ-(CH₃)₂Si(7,7-diethyl-3,6,7,8-tetrahydro-as-indacen-3-yl)(t-butylamido)M(R)₂; μ-(CH₃)₂Si(2,6,6-trimethyl-1,5,6,7-tetrahydro-s-indacen-1-yl)(cyclododecylamido)M(R)₂; μ-(CH₃)₂Si(6,6-dimethyl-1,5,6,7-tetrahydro-s-indacen-1-yl)(cyclododecylamido)M(R)₂; μ-(CH₃)₂Si(2-methyl-6,6-diethyl-1,5,6,7-tetrahydro-s-indacen-1-yl)(cyclododecylamido)M(R)₂; μ-(CH₃)₂Si(6,6-diethyl-1,5,6,7-tetrahydro-s-indacen-1-yl)(cyclododecylamido)M(R)₂; μ-(CH₃)₂Si(2,7,7-trimethyl-3,6,7,8-tetrahydro-as-indacen-3-yl)(cyclododecylamido)M(R)₂; μ-(CH₃)₂Si(7,7-dimethyl-3,6,7,8-tetrahydro-as-indacen-3-yl)(cyclododecylamido)M(R)₂; μ-(CH₃)₂Si(2-methyl-3,6,7,8-tetrahydro-as-indacen-3-yl)(cyclododecylamido)M(R)₂; μ-(CH₃)₂Si(2-methyl-7,7-diethyl-3,6,7,8-tetrahydro-as-indacen-3-yl)(cyclododecylamido)M(R)₂; μ-(CH₃)₂Si(7,7-diethyl-3,6,7,8-tetrahydro-as-indacen-3-yl)(cyclododecylamido)M(R)₂; μ-(CH₂)₃Si(2,6,6-trimethyl-1,5,6,7-tetrahydro-s-indacen-1-yl)(t-butylamido)M(R)₂; μ-(CH₂)₄Si(2,6,6-trimethyl-1,5,6,7-tetrahydro-s-indacen-1-yl)(t-butylamido)M(R)₂; μ-(CH₂)₅Si(2,6,6-trimethyl-1,5,6,7-tetrahydro-s-indacen-1-yl)(t-butylamido)M(R)₂; μ-(CH₃)₂C(2,6,6-trimethyl-1,5,6,7-tetrahydro-s-indacen-1-yl)(t-butylamido)M(R)₂; μ-(CH₂)₃Si(2,6,6-trimethyl-1,5,6,7-tetrahydro-s-indacen-1-yl)(t-butylamido)M(R)₂; μ-(CH₂)₄Si(2,6,6-trimethyl-1,5,6,7-tetrahydro-s-indacen-1-yl)(t-butylamido)M(R)₂; μ-(CH₂)₅Si(2,6,6-trimethyl-1,5,6,7-tetrahydro-s-indacen-1-yl)(t-butylamido)M(R)₂; μ-(CH₃)₂C(2,6,6-trimethyl-1,5,6,7-tetrahydro-s-indacen-1-yl)(t-butylamido)M(R)₂; and μ-(CH₃)₂Si(2,6,6-trimethyl-1,5,6,7-tetrahydro-s-indacen-1-yl)(neopentylamido)M(R)₂; where M is selected from Ti, Zr, and Hf and R is selected from halogen or C₁ to C₅ alkyl, such as R is a methyl group or a halogen group, such as M is Ti.

In alternative embodiments, a catalyst system can include two or more different transition metal compounds. For purposes of the present disclosure one transition metal compound is considered different from another if they differ by at least one atom. For example “Me₂Si(2,7,7-Me₃-3,6,7,8-tetrahydro-as-indacen-3-yl)(cyclohexylamido)TiCl₂” is different from Me₂Si(2,7,7-Me₃-3,6,7,8-tetrahydro-as-indacen-3-yl)(n-butylamido)TiCl₂” which is different from Me₂Si(2,7,7-Me₃-3,6,7,8-tetrahydro-as-indacen-3-yl)(n-butylamido) HfCl₂.

In at least one embodiment, one mono-tetrahydroindacenyl compound as described herein is used in the catalyst system.

In some embodiments, Formula (VII) is represented by:

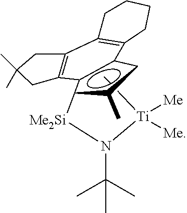

The catalyst compound can be represented by the Formula (VIII):

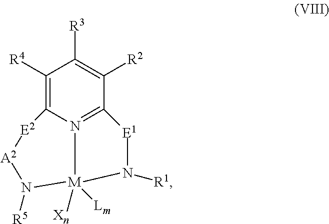

where M is a group 3, 4, 5 or 6 transition metal or lanthanide metal;
A² is selected from the group consisting of aryl, substituted aryl, heteroaryl, and substituted heteroaryl group;
E¹ is selected from the group consisting of hydrocarbyl, substituted hydrocarbyl, silyl, and substituted silyl, E¹ is optionally fused with R² to form one or more hydrocarbyl rings, substituted hydrocarbyl rings, heterocyclic rings, or substituted heterocyclic rings;
E² is selected from the group consisting of hydrocarbyl, substituted hydrocarbyl, silyl, and substituted silyl, E² is optionally fused with the A² to form one or more hydrocarbyl rings, substituted hydrocarbyl rings, heterocyclic rings, or substituted heterocyclic rings;
each L is independently a Lewis base;
each X is independently an anionic ligand;
n is 1, 2 or 3;
m is 0, 1, or 2;
n+m is not greater than 4;
each R¹, R², R³, and R⁴ is independently selected from the group consisting of C₁-C₄₀ hydrocarbyl, substituted C₁-C₄₀ hydrocarbyl, a heteroatom-containing group, and substituted heteroatom-containing group;
R⁵ is an unsubstituted hydrocarbyl ring, substituted hydrocarbyl rings, heterocyclic rings, substituted heterocyclic rings, unsubstituted aromatic ring, or substituted aromatic ring;
any two L groups may be joined together to form a bidentate Lewis base;
an X group may be joined to an L group to form a monoanionic bidentate group; and
any two X groups may be joined together to form a dianionic ligand group.

In at least one embodiment, the catalyst compounds represented by Formula (VIII) feature one seven-membered and one five-membered metallocycle rings. The seven-membered metallocycle rings contain the metal M, a nitrogen, two atoms of the aryl or substituted aryl group A², one atom of the hydrocarbyl or substituted hydrocarbyl group E², and two atoms from the bridging Lewis base. The five-membered metallocycle ring contains the atoms from the metal M, a nitrogen, an atom from the hydrocarbyl or substituted hydrocarbyl group E¹, and two atoms from the bridging Lewis base.

In some embodiments, the metal M is a group 4 metal, such as zirconium or hafnium.

In at least one embodiment, each L of the catalysts represented by Formula (VIII) can be independently selected from the group consisting of ethers, amines, phosphines, thioethers, esters, Et₂O, MeO^{t}Bu, Et₃N, PhNMe₂, MePh₂N, tetrahydrofuran, and dimethylsulfide. In at least one embodiment, m of the catalysts represented by Formula (VIII) is 0. In at least one embodiment, each X the catalysts represented by Formula (VIII) can be independently selected from the group consisting of methyl, benzyl, trimethylsilyl, neopentyl, ethyl, propyl, butyl, phenyl, hydrido, chloro, fluoro, bromo, iodo, trifluoromethanesulfonate, dimethylamido, diethylamido, dipropylamido, and diisopropylamido, such as chloro, such as methyl. In at least one embodiment, n of the catalysts represented by Formula (VIII) is 2.

In some embodiments, X is selected from methyl, or benzyl, n is 2, and m is zero.

In some embodiments, E¹ can be selected from the group consisting of C(R¹⁵)(R¹⁶) and Si(R¹⁵)(R¹⁶). Each of R¹⁵ and R¹⁶ may be independently selected from the group consisting of hydrogen, C₁-C₄₀ hydrocarbyl, substituted C₁-C₄₀ hydrocarbyl, a heteroatom, heteroatom containing group, and substituted heteroatom-containing group, or R¹⁵ and R¹⁶ may be joined to form one or more C₃-C₂₀ alkyl groups, hydrocarbyl rings, substituted hydrocarbyl rings, heterocyclic rings, or substituted heterocyclic rings each having 5, 6, 7, or 8 ring atoms, and where substitutions on the ring can join to form additional rings.

In some embodiments, E² can be selected from the group consisting of C(R²⁵)(R²⁶), Si(R²⁵)(R²⁶), and C═C(R²⁵)(R²⁶). Each of R²⁵ and R²⁶ may be independently selected from the group consisting of hydrogen, C₁-C₄₀ hydrocarbyl, substituted C₁-C₄₀ hydrocarbyl, a heteroatom, heteroatom containing group, and substituted heteroatom-containing group, or R²⁵ and R²⁶ may be joined to form one or more C₃-C₂₀ alkyl groups, hydrocarbyl rings, substituted hydrocarbyl rings, heterocyclic rings, or substituted heterocyclic rings each having 5, 6, 7, or 8 ring atoms, and where substitutions on the ring can join to form additional rings.

In some embodiments, E¹ and E² are independently selected from —CH₂, —CMe₂, —CEt₂, —CHMe, —CHEt, —CPh₂, —CHPh, —SiMe₂, —SiEt₂, —SiPh₂, —SiMePh, such as —CH₂.

In some embodiments, E¹ is selected from CH₂, CMe₂, CEt₂, CHMe, CHEt, CPh₂, CHPh, SiMe₂, SiEt₂, SiPh₂, SiMePh, and E² is selected from CH₂, CMe₂, CEt₂, CHMe, CHEt, CPh₂, CHPh, SiMe₂, SiEt₂, SiPh₂, SiMePh, C═CH₂, C═CMe₂, C═CEt₂, C═CPh₂, C═CHMe, C═CHEt, and C═CHPh.

In some embodiments, E¹ is CH₂ and E² is selected from CH₂ and C═CMe₂.

In at least one embodiment, R¹ is selected from a substituted or unsubstituted C₇-C₄₀ hydrocarbyl, such as a phenyl group, methylphenyl group, a dimethylphenyl group, a trimethylphenyl group, a tetramethylphenyl group, a pentamethylphenyl group, an ethylphenyl group, a diethylphenyl group, a triethylphenyl group, an isopropylphenyl group, a diisopropylphenyl group, a triisopropylphenyl group, a tert-butylphenyl group, a di-tert-butylphenyl group, a tri-tert-butylphenyl group, a methylisopropylphenyl group, a methyl-tert-butlyphenyl group, an ethylisopropylphenyl group, an ethyl-tert-butylphenyl group, a methylnaphthalenyl group, an ethylnaphthalenyl group, an isopropylnaphthalenyl group, and a tert-butylnaphthalenyl group. Alternatively, R¹ is selected from the group consisting of methyl, ethyl, and all isomers of propyl, butyl, pentyl, hexyl, heptyl, octyl, nonyl, and decyl.

In some embodiments, R¹ is selected from 2,6-dimethylphenyl, 2,6-diethylphenyl, 2,6-diisopropylphenyl, 2,4,6-trimethylphenyl, and 2,6-diisopropyl-4-methylphenyl.

In some embodiments, each of R², R³, and R⁴ is independently selected from the group consisting of hydrogen, C₁-C₄₀ hydrocarbyl, substituted C₁-C₄₀ hydrocarbyl, a heteroatom, and heteroatom-containing group, or one or more of R² and R³ or R³ and R⁴ may be joined to form one or more hydrocarbyl rings, substituted hydrocarbyl rings, heterocyclic rings, or substituted heterocyclic rings each having 5, 6, 7, or 8 ring atoms, and where substitutions on the ring can join to form additional rings. In at least one embodiment, each of R², R³, and R⁴ is independently selected from the group consisting of hydrogen and C₁-C₁₀ alkyl. In at least one embodiment, each of R², R³, and R⁴ is independently selected from the group consisting of hydrogen, methyl, ethyl, and all isomers of propyl, butyl, pentyl, hexyl, heptyl, octyl, nonyl, and decyl.

In some embodiments, R⁵ is selected from a substituted or unsubstituted C₇-C₄₀ hydrocarbyl, such as a phenyl group, methylphenyl group, a dimethylphenyl group, a trimethylphenyl group, a tetramethylphenyl group, a pentamethylphenyl group, an ethylphenyl group, a diethylphenyl group, a triethylphenyl group, an isopropylphenyl group, a diisopropylphenyl group, a triisopropylphenyl group, a tert-butylphenyl group, a di-tert-butylphenyl group, a tri-tert-butylphenyl group, a methylisopropylphenyl group, a methyl-tert-butlyphenyl group, an ethylisopropylphenyl group, an ethyl-tert-butylphenyl group, a methylnaphthalenyl group, an ethylnaphthalenyl group, an isopropylnaphthalenyl group, and a tert-butylnaphthalenyl group. Alternatively, R¹ is selected from the group consisting of methyl, ethyl, and all isomers of propyl, butyl, pentyl, hexyl, heptyl, octyl, nonyl, and decyl. For example, R⁵ is a phenyl group.

In at least one embodiment, A² of Formula (VIII) is represented by:

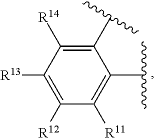

wherein each of R¹¹, R¹², R¹³, and R¹⁴ is independently selected from the group consisting of hydrogen, C₁-C₄₀ hydrocarbyl, substituted C₁-C₄₀ hydrocarbyl, a heteroatom, heteroatom-containing group, and a substituted heteroatom-containing group. In at least one embodiment, each of R¹¹, R¹², R¹³, and R¹⁴ is independently selected from the group consisting of hydrogen and C₁-C₁₀ alkyl. In at least one embodiment, each of R¹¹, R¹², R¹³, and R¹⁴ is independently selected from the group consisting of hydrogen, methyl, ethyl, and all isomers of propyl, butyl, pentyl, hexyl, heptyl, octyl, nonyl, decyl, undecyl and dodecyl. In some embodiments, R¹¹ is a C₁-C₂₀ hydrocarbyl or substituted hydrocarbyl, such as 9-methylfluorenyl. In some embodiments, R¹¹ can be C₁-C₁₀ alkyl, such as tert-butyl or adamantyl, or substituted adamantyl, or R¹¹ can be a heteroatom-containing group such as trimethylsilyl, carbazol-9-yl or substituted carbazol-9-yl. Alternatively, R¹¹ can be aryl or substituted aryl, such as defined for R¹. In some embodiments, R¹³ is a C₁-C₂₀ hydrocarbyl such as for example methyl, tert-butyl, n-octyl and the like.

In some embodiments, R¹¹ is selected from tert-butyl, adamantyl, substituted adamantyl, carbazol-9-yl or substituted carbaxol-9-yl, phenyl, or substituted phenyl.

In some embodiments, R¹³ is selected from methyl or tert-butyl.

In some embodiments, Formula (VIII) is represented by:

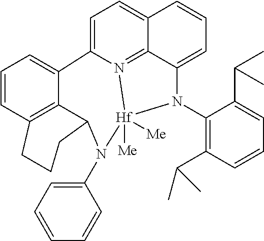

In some embodiments, the catalyst compound is represented by Formula (IX):

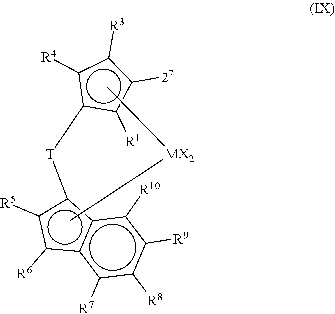

where M is a group 4 metal, such as titanium (Ti), zirconium (Zr), or hafnium (Hf);
each of R¹, R², R³, R⁴, R⁵, R⁶, R⁷, R⁸, R⁹, and R¹⁰ is independently hydrogen, substituted or unsubstituted hydrocarbyl, a substituted or unsubstituted heteroatom, or a substituted or unsubstituted heteroatom-containing group; optionally, one or more of R¹ and R², R² and R³, R³ and R⁴, R⁵ and R⁶, R⁷ and R⁸, R⁸ and R⁹, and R⁹ and R¹⁰ can be joined to form a substituted or unsubstituted completely saturated ring or a substituted or unsubstituted aromatic ring,
T represents the formula R^{a}₂J, (R^{a})₄J₂, or (R^{a})₆J₃ wherein each J is independently C, Si, or Ge, and each R^{a} is independently hydrogen, halide, a substituted or unsubstituted C₁ to C₄₀ hydrocarbyl, and wherein two R^{a} optionally can be joined to form a substituted or unsubstituted cyclic structure including a substituted or unsubstituted completely saturated ring, or a substituted or unsubstituted partially saturated ring (such as, such ring structure has from 2-10 carbon atoms in addition to the J atom, and also the ring structure is such as saturated); and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene;
where at least one of R⁵ or R⁶ is independently a substituted or unsubstituted aryl group or a substituted or unsubstituted heteroaryl group.

In some embodiments, at least one of R¹ and R², R² and R³, R³ and R⁴ of Formula (IX) is joined to form a substituted or unsubstituted completely saturated ring or a substituted or unsubstituted aromatic ring. In some embodiments, at least one of R⁵ and R⁶, R⁷ and R⁸, R⁸ and R⁹, and R⁹ and R¹⁰ of Formula (IX) is joined to form a substituted or unsubstituted completely saturated ring or a substituted or unsubstituted aromatic ring.

In some embodiments of Formula (IX), T is represented by the formula R^{a}₂J, (R^{a})₄J₂, or (R^{a})₆J₃ where J is C, Si, or Ge, and each R^{a} is independently hydrogen or C₁ to C₂₀ hydrocarbyl. In some embodiments, two R^{a} can form a cyclic structure including unsubstituted completely saturated, partially saturated, or aromatic ring. In some embodiments, T is selected from CH₂, CH₂CH₂, C(CH₃)₂, CPh₂, SiMe₂, SiEt₂, SiMeEt, SiPr₂, SiBu₂, SiPh₂, SiMePh, Si(CH₂)₃, Si(CH₂)₄, or Si(CH₂)₅. In some embodiments, T is SiMe₂, SiEt₂, SiPr₂, SiBu₂, or, more such as, T is a ring structure such as Si(CH₂)₃ (silacyclobutyl), Si(CH₂)₄ (silacyclopentyl), or Si(CH₂)₅ (silacyclohexyl).

In some embodiments of Formula (IX), M is a group 4 metal, such as titanium (Ti), zirconium (Zr), or hafnium (Hf). In some embodiments, M is Zr or Hf. In some embodiments, each X is independently a halide, such as chloro. In yet other embodiments, each X is independently a C₁-C₄ alkyl, such as methyl. In some embodiments, each X is independently selected from substituted or unsubstituted hydrocarbyl, a heteroatom or substituted or unsubstituted heteroatom-containing group, such as methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments of Formula (IX), is

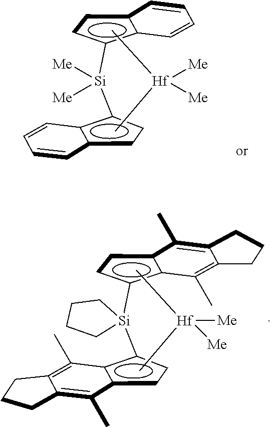

In at least one embodiment of the present disclosure, the catalyst systems include the product of the combination of one or more support materials. In some embodiments, a support material is a porous support material, for example, talc, and inorganic oxides. Other support materials include zeolites, clays, organoclays, or any other organic or inorganic support material, or mixtures thereof. As used herein, “support” and “support material” are used interchangeably.

In at least one embodiment, a support material is an inorganic oxide in a finely divided form. Suitable inorganic oxide materials for use in the supported catalyst systems herein include Groups 2, 4, 13, and 14 metal oxides such as silica, alumina, and mixtures thereof. Other inorganic oxides that may be employed, either alone or in combination, with the silica or alumina are magnesia, titania, zirconia, and the like. Other suitable support materials, however, can be employed, for example, finely divided functionalized polyolefins such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Exemplary support materials include Al₂O₃, ZrO₂, SiO₂, and combinations thereof, such as, SiO₂, Al₂O₃, or SiO₂/Al₂O₃.

The terms “cocatalyst” and “activator” are used herein interchangeably and include a compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Activators typically include non-coordinating anion compounds, alumoxane compounds, modified alumoxane compounds, and ionizing anion precursor compounds that abstract a reactive, σ-bound, metal ligand making the metal complex cationic and providing a charge-balancing noncoordinating or weakly coordinating anion.

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. Optionally, a visually clear methylalumoxane may be used. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under U.S. Pat. No. 5,041,584).

When the activator is an alumoxane (modified or unmodified), some embodiments select the maximum amount of activator typically at up to a 5,000-fold molar excess Al/M over the catalyst compound (per metal catalytic site). The minimum activator-to-catalyst-compound is a 1:1 molar ratio. Alternate ranges include from 1:1 to 500:1, alternately from 1:1 to 200:1, alternately from 1:1 to 100:1, or alternately from 1:1 to 50:1.

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral byproduct from the anion. Non-coordinating anions useful in accordance with the present disclosure are those that are compatible, stabilize the transition metal cation in the sense of balancing its ionic charge at +1, and yet retain sufficient lability to permit displacement during polymerization. Ionizing activators useful herein typically comprise an NCA, particularly a compatible NCA.

In some embodiments, the activator is an ionizing activator, neutral or ionic. In some embodiments of the present disclosure, neutral or ionic activators can be used alone or in combination with alumoxane or modified alumoxane activators.

In some embodiments, the catalyst systems of the present disclosure can include at least one non-coordinating anion (NCA) activator. In at least one embodiment, boron containing NCA activators can be used, wherein the boron containing NCA activator is represented by the Formula: (Z)_{d}⁺(A^{d-}), wherein: Z is (L-H) or a reducible Lewis acid; L is a Lewis base; His hydrogen; (L-H) is a Bronsted acid; A^{d-} is a boron containing non coordinating anion having the charge d−; d is 1, 2, or 3.

The cation component, Z_{d}+ may include Bronsted acids such as protons or protonated Lewis bases or reducible Lewis acids capable of protonating or abstracting a moiety, such as an alkyl or aryl, from the bulky ligand transition metal catalyst precursor, resulting in a cationic transition metal species.

The activating cation Z_{d}+ may also be a moiety such as silver, tropylium, carbeniums, ferroceniums and mixtures, such as carbeniums and ferroceniums. Z_{d}+ can be triphenyl carbenium. Reducible Lewis acids can be a triaryl carbenium (where the aryl can be substituted or unsubstituted, such as those represented by the formula: (Ar₃C+), where Ar is aryl or aryl substituted with a heteroatom, a C₁ to C₄₀ hydrocarbyl, or a substituted C₁ to C₄₀ hydrocarbyl), such as the reducible Lewis acids “Z” may include those represented by the formula: (Ph₃C), where Ph is a substituted or unsubstituted phenyl, such as substituted with C₁ to C₄₀ hydrocarbyls or substituted a C₁ to C₄₀ hydrocarbyls, such as C₁ to C₂₀ alkyls or aromatics or substituted C₁ to C₂₀ alkyls or aromatics, such as Z is a triphenylcarbenium. When Z_{d}+ is the activating cation (L-H)_{d}+, it can be a Bronsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether diethyl ether, tetrahydrofuran and dioxane, sulfoniums from thioethers, such as diethyl thioethers, tetrahydrothiophene, and mixtures thereof.

The anion component A^{d-} includes those having the formula [M^{k+}Qₙ]^{d-} where k is 1, 2, or 3; n is 1, 2, 3, 4, 5, or 6 (such as 1, 2, 3, or 4); n−k=d; M is an element selected from Group 13 of the Periodic Table of the Elements, such as boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Each Q can be a fluorinated hydrocarbyl group having 1 to 20 carbon atoms, such as each Q is a fluorinated aryl group, and such as each Q is a pentafluoryl aryl group. Examples of suitable A^{d-} also include diboron compounds as disclosed in U.S. Pat. No. 5,447,895, which is fully incorporated herein by reference.

Illustrative, but not limiting, examples of boron compounds which may be used as an activating cocatalyst are the compounds described as (and particularly those specifically listed as) activators in U.S. Pat. No. 8,658,556, which is incorporated by reference herein.

The ionic stoichiometric activator Z_{d}⁺ (A^{d-}) can be one or more of N,N-dimethylanilinium tetrakis(perfluorophenyl) borate, N,N-dimethylanilinium tetrakis(perfluoronaphthyl) borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

Alternately, the activator compounds are represented by Formula (X):

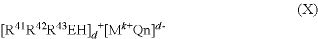

where E is nitrogen or phosphorous, such as nitrogen;
d is 1, 2 or 3 (such as 3); k is 1, 2, or 3 (such as 3); n is 1, 2, 3, 4, 5, or 6 (such as 4, 5, or 6); n−k=d (such as d is 1, 2 or 3; k is 3; n is 4, 5, or 6, such as when M is B, n is 4);
each of R⁴¹, R⁴², and R⁴³ is independently H, optionally substituted C₁-C₄₀ alkyl (such as branched or linear alkyl), or optionally substituted C₅-C₅₀ aryl (alternately each of R⁴¹, R⁴², and R⁴³ is independently unsubstituted or substituted with at least one of halide, C₅-C₅₀ aryl, C₆-C₃₅ arylalkyl, C₆-C₃₅ alkylaryl and, in the case of the C₅-C₅₀ aryl, C₁-C₅₀ alkyl);
wherein R⁴¹, R⁴², and R⁴³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms), such as at least one of R⁴¹, R⁴², and R⁴³ is a C₃ to C₄₀ hydrocarbyl, (such as a C₃-C₄₀ alkyl, alternately such as a C₇-C₄₀ alkyl);
M is an element selected from group 13 of the Periodic Table of the Elements, such as B or Al, and
each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, such as a fluorinated aryl group, such as a fluoro-phenyl or fluoro-naphthyl, such as perfluorophenyl or perfluoronaphthyl.

In some embodiments of Formula (X), each of R⁴¹, R⁴², and R⁴³ are independently selected from a substituted linear alkyl, a substituted branched alkyl, a substituted arylalkyl, a substituted silyl group, a substituted alkoxy group, a halogen, a halogen containing group, and combinations thereof.

In some embodiments, substituted linear alkyls can include, but a not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, and any isomer thereof.

In some embodiments, a substituted branched alkyl can include, but is not limited to, alkylbutyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkylpentadecyl, alkyl-hexadecyl, alkyl-heptadecyl, alkyloctadecyl, alkyl-nonadecyl, alkyl-eicosyl, and isomers thereof. In some embodiments, the substituted branched alkyl is a multi-alkyl analog, such as dialkyl-butyl, dialkyl-pentyl, dialkyl-hexyl, dialkyl-heptyl, dialkyl-octyl, dialkylnonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyloctyl, trialkyl-nonyl, trialkyl-decyl, trialkyl-undecyl, trialkyl-dodecyl, trialkyl-tridecyl, trialkyl-butadecyl, trialkyl-pentadecy I, trialkyl-hexadecy I, trialky 1-heptadecyl, trialkyl-octadecyl, trialkyl-nonadecyl, trialkyl-icosyl, and isomers thereof. In some embodiments, substituted branched alkyl is independently a C₁ to C₄₀ linear, branched or cyclic alkyl group, such as C₂ to C₃₀ linear, branched or cyclic alkyl group, such as C₃ to C₂₀ linear, branched or cyclic alkyl group. In some embodiments, the alkyl group of the substituted branched alkyl is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, tricontyl, and isomers thereof.

In some embodiments, a substituted arylalkyl include methylphenyl, ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, nonadecylphenyl, icosylphenyl, henicosylphenyl, docosylphenyl, tricosylphenyl, tetracosylphenyl, pentacosylphenyl, hexacosylphenyl, heptacosylphenyl, octacosylphenyl, nonacosylphenyl, tricontylphenyl, 3,5,5-trimethylhexylphenyl, dioctylphenyl, 3,3,5-trimethylhexylphenyl, 2,2,3,3,4 pentamethypentylylphenyl, and isomers thereof.

In some embodiments, a substituted silyl group include a trialkylsilyl group, wherein each alkyl is independently a substituted C₁ to C₂₀ alkyl, such as trimeth ylsilyl, triethylsilyl, tripropylsilyl, tributylsilyl, trihexylsilyl, triheptylsilyl, trioctylsilyl, trinonylsilyl, tridecylsilyl, triundecylsilyl, tridodecylsilyl, tritridecylsilyl, tri-tetradecylsilyl, tri-pentadecylsilyl, trihexadecylsilyl, tri-heptadecylsilyl, tri-octadecylsilyl, tri-nonadecylsilyl, tri-icosylsilyl, and isomers thereof.

In some embodiments, a substituted alkoxy group can be represented by the Formula —OR*, where R* includes a substituted C₁ to C₂₀ alkyl or aryl group, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, phenyl, naphthyl, anthracenyl, and combinations thereof. In some embodiments, R* can includes an alkylphenyl group, such as methyl phenyl, propyl phenyl, and isomers thereof.

In some embodiments, a halogen includes Br and Cl. In some embodiments, a halogen containing group includes bromomethyl and bromophenyl.

In some embodiments, the NCA can include one or more of:
N,N-di(hydrogenated tallow)methylammonium [tetrakis(perfluorophenyl)borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

In some embodiments, the activator is selected from one or more of a triaryl carbenium compounds including triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate.

In another embodiment, the activator is selected from one or more of trialkylammonium tetrakis(pentafluorophenyl)borate, N,N-dialkylanilinium tetrakis(pentafluorophenyl)borate, dioctadecylmethylammonium tetrakis(perfluoronaphthyl)borate, N,N-dimethyl-(2,4,6-trimethylanilinium) tetrakis(pentafluorophenyl)borate, trialkylammonium tetrakis-(2,3,4,6-tetrafluorophenyl)borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl) borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, N-methyl-4-nonadecyl-Noctadecylanilinium tetrakis(perfluoronaphthalen-2-yl)borate, N-methyl 1-4-nonadecy 1-N-octadecylanilinium tetrakis(perfluorophenyl)borate.

Suitable activator-to-catalyst ratio for catalyst systems having NCA activators, an activator-to-catalyst ratio may be about a 1:1 molar ratio. In some embodiments, the activator-to-catalyst ratio ranges from about 0.5:1 to about 1,000:1, such as from about 0.5:1 to about 500:1, such as from about 1:1 to about 250:1, such as about 1:1 to about 1,000:1. In some embodiments, the activator-to-catalyst ratio is from about 0.5:1 to about 10:1, such as about 1.2:1 to about 5:1.

In some embodiments, any one or more catalyst compounds, one or more alumoxanes, one or more NCA, and one or more activators may be combined in any amount or ratio to form a catalyst system to produce a desired result, such as, but not limited to, a polymer having a desired architecture, molecular weight, physical properties, thermal properties, and combinations thereof.

In addition to the activators, scavengers, chain transfer agents or co-activators may be used. Aluminum alkyl or organoaluminum compounds which may be utilized as co-activators include, for example, trimethylaluminum, triethylaluminum, triisobutylaluminum, tri-n-hexylaluminum, tri-n-octylaluminum, diethyl zinc, tri-n-butylaluminum, diisobutylaluminum hydride, or combinations thereof.

In at least one embodiment, the catalyst systems can additionally comprise one or more scavenging compounds. Here, the term “scavenger” means a compound that removes polar impurities from the reaction environment. These impurities adversely affect catalyst activity and stability. For example, the scavenging compound will be an organometallic compound such as the Group-13 organometallic compounds of U.S. Pat. Nos. 5,153,157; 5,241,025; and WO 1991/009882; WO 1994/003506; WO 1993/014132; and that of WO 1995/007941. Exemplary compounds include triethyl aluminum, triethyl borane, tri-iso-butyl aluminum, methyl alumoxane, iso-butyl alumoxane, and tri-n-octyl aluminum. Those scavenging compounds having bulky or C₆-C₂₀ linear hydrocarbyl substituents connected to the metal or metalloid center usually minimize adverse interaction with the active catalyst. Examples include triethyl aluminum, and bulky compounds such as tri-iso-butyl aluminum, tri-iso-prenyl aluminum, and long-chain linear alkyl-substituted aluminum compounds, such as tri-n-hexyl aluminum, tri-n-octyl aluminum, or tri-n-dodecyl aluminum.

When alumoxane is used as the activator, any excess over that needed for activation will scavenge impurities and additional scavenging compounds may be unnecessary. Alumoxanes also may be added in scavenging quantities with other activators, e.g., methylalumoxane, [Me₂HNPh]⁺[B(pfp)₄]⁻ or B(pfp)₃ (perfluorophenyl=pfp=C₆F₅).

Exemplary aluminum scavengers can include those where there is oxygen present. That is, the material per se or the aluminum mixture used as a scavenger, includes an aluminum/oxygen species, such as an alumoxane or alkylaluminum oxides, e.g., dialkyaluminum oxides, such as bis(diisobutylaluminum) oxide. In at least one aspect, aluminum containing scavengers can be represented by the formula ((R_{z}—Al—)_{y}O—)ₓ, wherein z is 1-2, y is 1-2, x is 1-100, and R is a C₁-C₁₂ hydrocarbyl group. In another aspect, the scavenger has an oxygen to aluminum (O/Al) molar ratio in a range from about 0.25 to about 1.5, more particularly from about 0.5 to about 1. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and diethyl zinc.

Chain transfer agents may be used in the compositions and/or processes described herein. Useful chain transfer agents are typically alkylalumoxanes, a compound represented by the formula AlR₃, ZnR₂ (where each R is, independently, a C₁-C₈ aliphatic radical, such as methyl, ethyl, propyl, butyl, pentyl, hexyl, octyl or an isomer thereof) or a combination thereof, such as diethyl zinc, methylalumoxane, trimethylaluminum, triisobutylaluminum, trioctylaluminum, or a combination thereof.

In some embodiments, the monomer feed includes a solvent and/or diluent. Suitable diluents/solvents include non-coordinating, inert liquids. In at least one embodiment, a solvent/diluent includes straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In some embodiments, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the catalyst system includes a solvent in an amount of about 80 vol % or less, based on the total volume of the of the catalyst system. In at least one embodiment, the catalyst system includes a solvent in an amount of about 80 wt %, based on the total weight of the catalyst system.

In at least one embodiment, the catalyst system is introduced to the reactor at a feed rate of about 0.1 mL/min to about 2.5 mL/min, such as about 0.5 mL/min to about 2 mL/min, such as about 1 mL/min to about 1.5 mL/min, alternatively about 0.1 mL/min to about 0.5 mL/min, alternatively about 0.5 mL/min to about 1 mL/min, alternatively about 1 mL/min to about 1.25 mL/min, alternatively about 1.25 mL/min to about 1.5 mL/min, alternatively about 1.5 mL/min to about 2 mL/min, alternatively about 2 mL/min to about 2.5 mL/min.

At operation 106 of the method 100, the reaction mixture is polymerized such that the monomeric components of the monomer feed react to form a polymer mixture. Generally, the polymerization process is conducted through contacting the monomer feed with the catalyst system, as described above. Each of the components of the monomer feed and catalyst system may be combined in any suitable order, sequence, or processes know to one of ordinary skill in the art. In at least one embodiment, the catalyst system is fully prepared prior to contacting with the monomer feed.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. A bulk homogeneous process can be used. Alternately, no solvent or diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed, and monomers are polymerized on the supported catalyst particles. At least 95 wt % of polymer products derived from the supported catalyst are in granular form as solid particles (not dissolved in the diluent).

The polymerization process can be run at any temperature and/or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In some embodiments, the run time of the polymerization reaction can be up to about 1,500 minutes, such as about 1,200 minutes, such as about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 180 minutes.

In some embodiments, an inert gas may be introduced to the polymerization reactor during the polymerization. The inert gas may be or include nitrogen, hydrogen, or a combination thereof. In at least one embodiment, hydrogen is present in the polymerization reactor at a partial pressure of about 0.001 psig to about 200 psig (0.007 kPa to 1,380 kPa), such as about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa). In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

A “reaction zone” also referred to as a “polymerization zone” is a vessel where polymerization takes place, for example a stirred-tank reactor or a loop reactor. When multiple reactors are used in a continuous polymerization process, each reactor is considered as a separate reaction zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylalumoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

In some embodiments, the polymerization process is a solution phase polymerization process. A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are not turbid as described in Oliveira, J. V. et al. (2000) Ind. Eng, Chem. Res. v. 29, pg. 4627. Solution polymerization may involve polymerization in a continuous reactor in which the polymer formed, the monomer feed and catalyst system materials supplied are agitated to reduce or avoid concentration gradients and in which the monomer acts as a diluent or solvent or in which a hydrocarbon is used as a diluent or solvent. Suitable processes can operate at temperatures from about 0° C. to about 250° C., such as from about 50° C. to about 170° C., such as from about 80° C. to about 150° C., and/or at pressures of about 0.1 MPa or more, such as 0.5 MPa or more. The upper pressure limit is not critically constrained but can be about 200 MPa or less, such as 120 MPa or less, such as 30 MPa or less. Temperature control in the reactor can be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

A process described herein can be a solution polymerization process that may be performed in a batchwise fashion (e.g., batch; semi-batch) or in a continuous process. Suitable reactors may include tank, loop, and tube designs. In at least one embodiment, the process is performed in a continuous fashion and dual loop reactors in a series configuration are used. In at least one embodiment, the process is performed in a continuous fashion and dual continuous stirred-tank reactors (CSTRs) in a series configuration are used. Furthermore, the process can be performed in a continuous fashion and a tube reactor can be used. In another embodiment, the process is performed in a continuous fashion and one loop reactor and one CSTR are used in a series configuration. The process can also be performed in a batchwise fashion, and a single stirred tank reactor can be used.

In some embodiments, the polymer mixture produced from the polymerization reaction of operation 106 includes a terpolymer composed of the monomer compounds of the monomer feed. The olefin monomers of the monomer feed can include ethylene, a C₁₀-C₁₈ linear α-olefin monomer, and 2-ethylidene-5-norborene. In at least one embodiment, the poly(alpha olefin) terpolymer can be represented by Formula (XI):

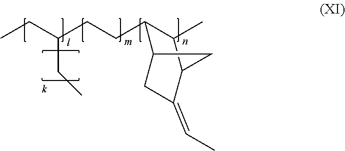

wherein each of k, l, m, and n is independently an integer of greater than 1, such as about 1 to about 1,000. In at least one embodiment, the poly(alpha olefin) terpolymer is composed of ethylene units, C₁₀-C₁₈ linear α-olefin monomer units, and 2-ethylidene-5-norborene monomer units. The poly(alpha olefin) terpolymer may include a number of ethylene units, wherein the number of ethylene units is denoted by m. The poly(alpha olefin) terpolymer may include a number of C₁₀-C₁₈ linear α-olefin monomer units, wherein the number of C₁₀-C₁₈ linear α-olefin monomer units is denoted by 1. The poly(alpha olefin) terpolymer may include a number of 2-ethylidene-5-norborene monomer units, wherein the number of 2-ethylidene-5-norborene monomer units is denoted by n. In some examples, the poly(alpha olefin) terpolymer may be or include 2-ethylidene-5-norborene, 5-vinyl-2-norbornene, norbornadiene, or any combination thereof.

In some embodiments, the efficiency of the polymerization reaction can be described in terms of catalyst activity (e.g., amount of polymer produced per amount of catalyst introduced to the polymer system) and overall polymer yield. In at least one embodiment, the catalyst activity is about 100,000 g polymer/g catalyst (g/g) to about 10,000,000 g/g, such as about 100,000 g/g to about 7,500,000 g/g, such as about 100,000 g/g to about 5,000,000 g/g, such as about 100,000 g/g to about 2,500,000 g/g, such as about 150,000 g/g to about 2,000,000 g/g, such as about 250,000 g/g to about 1,000,000 g/g, alternatively about 100,000 g/g to about 150,000 g/g, alternatively about 150,000 g/g to about 250,000 g/g, alternatively about 250,000 g/g to about 500,000 g/g, alternatively about 500,000 g/g to about 1,000,000 g/g, alternatively about 1,000,000 g/g to about 2,000,000 g/g, alternatively about 2,000,000 g/g to about 2,500,000 g/g. In some embodiment, the polymer yield of the polymerization reaction is about 100 g to about 5,000 g, such as about 150 g to about 1,000 g, such as about 250 g to about 500 g, alternatively about 100 g to about 150 g, alternatively about 150 g to about 250 g, alternatively about 500 g to about 1,000 g, alternatively about 1,000 g to about 5,000 g.

At operation 108 of the method 100, the polymer mixture is vulcanized to produce a polymer composition. The polymer mixture may be vulcanized according to a curing process, e.g., chemical curing process and/or ultraviolet (UV) curing process. In an embodiment, the chemical curing process can include introducing a crosslinking agent to the reactor.

The crosslinking agent may be introduced to the reactor with the polymer mixture. In some embodiments, the crosslinking agent is selected from oxygen (O₂), carbon dioxide (CO₂), air vented inform outside the second reactor, an organic peroxide such as dicumyl peroxide, peroxyacetic acid, sulfur, meta-chloroperoxybenzoic acid, or a combination thereof. The crosslinking agent can include a peroxide crosslinking agent, e.g., dicumyl peroxide and/or a sulfur crosslinking agent, e.g., sulfur.

In some embodiments, the UV curing process can include introducing a photo-initiator to the polymer mixture. The photo-initiator can include an organic photo-initiator such as 1-hydroxycyclohexyl phenyl ketone. The UV curing process can include exposing the polymer mixture to a UV light source. The UV light source can include a wavelength of about 100 nm to about 500 nm, such as about 100 nm to about 400 nm, e.g., about 350 nm to about 380 nm.

In some embodiments, the temperature within the reactor during and/or throughout operation 108 of the method 100 is about 50° C. to about 250° C., such as about 100° C. to about 200° C., such as about 125° C. to about 175° C., alternatively about 50° C. to about 100° C., alternatively about 100° C. to about 125° C., alternatively about 125° C. to about 150° C., alternatively about 150° C. to about 175° C., alternatively about 175° C. to about 200° C., alternatively about 200° C. to about 250° C. In some embodiments, the curing process can occur for a period of about 1 minute to about 12 hours, e.g., about 1 minute to about 10 hours, about 1 hour to about 10 hours, or about 1 hour to about 5 hours.

Vulcanizing the polymer mixture according to the chemical curing process and/or UV curing process quenches the polymerization reaction and/or promotes the formation of bottlebrush PAO polymers to form as a polymer chain. In other words, alkyl moieties of a terpolymer of the present disclosure are cross-linked to form the PAO polymer network. In at least one embodiment, the poly(alpha olefin) terpolymer is composed of ethylene units, C₁₀-C₁₈ linear α-olefin units, and 2-ethylidene-5-norborene units.

As previously discussed, the poly(alpha olefin) terpolymers formed via methods described herein include ethylene units, C₁₀-C₁₈ linear α-olefin units, and 2-ethylidene-5-norborene units. In some embodiments, the poly(alpha olefin) terpolymer has a weight average molecular weight (Mw) of about 5,000 g/mol or greater, such as about 5,000 g/mol to about 2,000,000 g/mol, such as about 10,000 g/mol to about 1,000,000 g/mol, such as about 10,000 g/mol to about 500,000 g/mol, such as about 20,000 g/mol to about 400,000 g/mol, such as about 40,000 g/mol to about 400,000 g/mol, such as about 50,000 g/mol to about 400,000 g/mol, such as about 100,000 g/mol to about 400,000 g/mol, such as about 120,000 g/mol to about 300,000 g/mol, such as about 150,000 g/mol to about 280,000 g/mol.

In at least one embodiment, the poly(alpha olefin) terpolymer has a number average molecular weight (Mn) of about 1,000 g/mol or greater, such as about 1,000 g/mol to about 400,000 g/mol, such as about 1,000 g/mol to about 200,000 g/mol, such as about 1,000 g/mol to about 180,000 g/mol, such as about 10,000 g/mol to about 150,000 g/mol, such as about 50,000 g/mol to about 100,000 g/mol, such as about 50,000 g/mol to about 900,000 g/mol.

In at least one embodiment, the poly(alpha olefin) terpolymers of the present disclosure can have an Mw/Mn (polydispersity index) value of about 1 to about 10, such as from about 2 to about 5, such as from about 2 to about 3.

In at least one embodiment, the poly(alpha olefin) terpolymer has a linear α-olefin content of about 50 wt % to about to about 95 wt % based on the weight of the poly(alpha olefin) terpolymer, such as about 50 wt % to about 90 wt %, such as about 50 wt % to about 85 wt %, such as about 50 wt % to about 80 wt %, such as about 50 wt % to about 75 wt %, such as about 50 wt % to about 70 wt %, such as about 50 wt % to about 65 wt %, such as about 50 wt % to about 60 wt %, such as about 50 wt % to about 55 wt %. In at least one embodiment, the poly(alpha olefin) terpolymer includes an ethylene content of about 0.1 wt % to about 50 wt % based on the weight of the poly(alpha olefin) terpolymer, such as about 1 wt % to about 50 wt %, such as about 10 wt % to about 50 wt %, such as about 20 wt % to about 50 wt %, such as about 30 wt % to about 50 wt %, such as about 40 wt % to about 50 wt %, such as about 45 wt % to about 50 wt %.

In at least one embodiment, the poly(alpha olefin) terpolymer may include an ethylene content of about 1 wt % to about 50 wt % based on the weight of the poly(alpha olefin) terpolymer, such as about 5 wt % to about 50 wt %, such as about 10 wt % to about 50 wt %, such as about 15 wt % to about 50 wt %, such as about 20 wt % to about 50 wt %, such as about 25 wt % to about 50 wt %, such as about 30 wt % to about 50 wt %, such as about 35 wt % to about 50 wt %, such as about 40 wt % to about 50 wt %, such as about 45 wt % to about 50 wt %.

In some embodiments, the poly(alpha olefin) terpolymer has a non-conjugated diene content of less than or about 10 wt %, such as less than or about 8 wt %, such as less than or about 5 wt %, such as less than or about 4 wt %.

In some embodiments, the mol ratio of ethylene to the linear α-olefin in the poly(alpha olefin) terpolymer composition is about 1:10 mol:mol to about 2:1 mol:mol of the ethylene to the linear α-olefin.

In some embodiments, the poly(alpha olefin) terpolymer has an elastic modulus about 1 kPa to about 2 MPa, such as about 1 kPa to about 0.2 MPa, such as about 1 kPa to about 0.1 MPa. In some embodiments, the poly(alpha olefin) terpolymer has a tensile strength in a range from about 30 kPa to about 140 kPa, such as about 40 kPa to about 130 kPa, such as about 50 kPa to about 120 kPa. In some embodiments, the poly(alpha olefin) terpolymer has a strain at break in a range from about 200% to about 1,200%, such as about 300% to about 1,100%, such as about 300% to about 1,000%. In some embodiments, the poly(alpha olefin) terpolymer has a permanent set in a range from about 1% to about 5%, such as about 2% to about 4%, such as about 2% to about 3%. In some embodiments, the poly(alpha olefin) terpolymer has negligible/or eliminated fatigue and/or hysteresis loss.

In some embodiments, the poly(alpha olefin) terpolymer has a compressive strength in a range from about 1 MPa to about 1.6 MPa, such as about 1 MPa to about 1.4 MPa such as about 1 MPa to about 1.2 MPa. In some embodiments, the poly(alpha olefin) terpolymer has a compressive set (at compressive strains of less than 80%) ranging about 1% to about 10%, such as about 2% to about 8%, such as about 4% to about 6%. In some embodiments, the poly(alpha olefin) terpolymer has a hysteresis loss energy (at compressive strains of less than 80%) of less than 1 kJ/m³, such as less than 0.8 kJ/m³, such as less than 0.6 kJ/m³. In some embodiments, the poly(alpha olefin) terpolymer has a complex modulus of about 1 kPa to about 100 kPa, such as about 1 kPa to about 90 kPa, such as about 20 kPa to about 80 kPa, such as about 40 kPa to about 60 kPa. In some embodiments, the poly(alpha olefin) terpolymer has a storage modulus of about 1 Pa to about 100 kPa, such as about 1 Pa to about 90 kPa, such as about 1 kPa to about 80 kPa, such as about 40 kPa to about 60 kPa. In some embodiments, the poly(alpha olefin) terpolymer has a maximum stress of about 0.1 kPa to about 1,000 kPa, such as about 1 kPa to about 500 kPa, such as about 10 kPa to about 100 kPa, such as about 40 kPa to about 60 kPa.

In some embodiments, the poly(alpha olefin) terpolymer has a glass transition temperature (T_{g}) of about −80° C. to about 0° C., such as about −75° C. to about −10° C., such as about −70° C. to about −60° C. In some embodiments, the poly(alpha olefin) terpolymer has a melting temperature (Tₘ) of about 20° C. to about 130° C., such as about 25° C. to about 110° C., such as about 25° C. to about 40° C. In some embodiments, the poly(alpha olefin) terpolymer has a crystallinity temperature (T_{C}) of about 10° C. to about 80° C., such as about 15° C. to about 71° C., such as about 15° C. to about 31° C. In some embodiments, the poly(alpha olefin) terpolymer has a latent heat (ΔHₘ) of about 3 J/g to about 200 J/g, such as about 60 J/g to about 187 J/g, such as about 100 J/g to about 187 J/g. Without being bound by theory, poly(alpha olefin) terpolymers of the present disclosure, having latent heats larger than 100 J/g and melting temperatures from about 15° C. to about 35° C., may provide encapsulation/support free shape stabilized PCMs.

### EXAMPLES

The foregoing discussion can be further described with reference to the following non-limiting examples.

### Example 1: Preparation of Reference 1

A 2 L autoclave reactor was charged with tri(n-octyl)aluminum (TNOAL, 2.0 mL of 25 wt % hexane solution; obtained from Sigma Aldrich), 1-decene (380 mL), and isohexane (600 mL). The mechanical stir was set at 700 rpm. The reactor was then heated to 75° C. and then charged with 20 psig ethylene. Isohexane (200 mL) was used to chase a non-coordinating anion activator represented by the Formula:

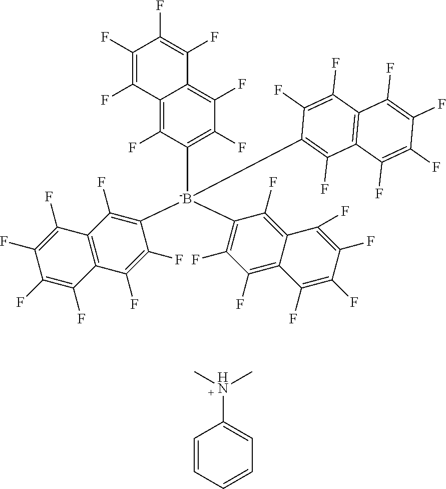

(25.1 mg, 5 mL toluene solution) and catalyst represented by the Formula:

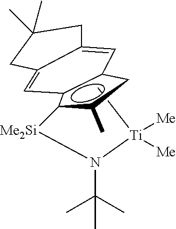

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 2: Preparation of Example 1

A 2 L autoclave reactor was charged with tri(n-octyl)aluminum (TNOAL, 2.0 mL of 25 wt % hexane solution; obtained from Sigma Aldrich), 1-decene (380 mL), ENB (10 mL), and isohexane (600 mL). The mechanical stir was set at 700 rpm. The reactor was then heated to 75° C. and then charged with 20 psig ethylene. Isohexane (200 mL) was used to chase a non-coordinating anion activator represented by the Formula:

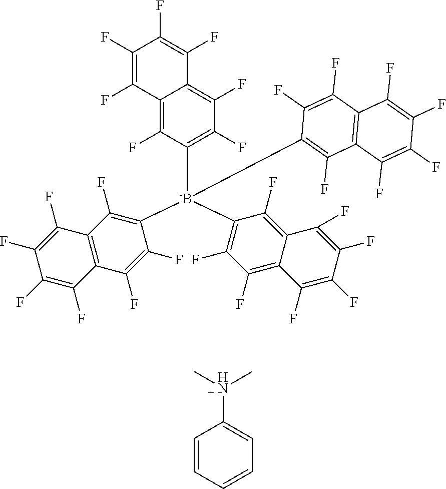

(25.1 mg, 5 mL toluene solution) and catalyst represented by the Formula:

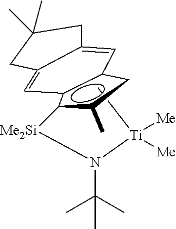

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 3: Preparation of Reference 2

A 2 L autoclave reactor was charged with tri(n-octyl)aluminum (TNOAL, 2.0 mL of 25 wt % hexane solution; obtained from Sigma Aldrich), 1-decene (360 mL), and isohexane (600 mL). The mechanical stir was set at 700 rpm. The reactor was then heated to 75° C. and then charged with 40 psig ethylene. Isohexane (200 mL) was used to chase a non-coordinating anion activator represented by the Formula:

### ° C. Example 4: Preparation of Example 2

A 2 L autoclave reactor was charged with tri(n-octyl)aluminum (TNOAL, 2.0 mL of 25 wt % hexane solution; obtained from Sigma Aldrich), 1-decene (360 mL), ENB (10 mL), and isohexane (600 mL). The mechanical stir was set at 700 rpm. The reactor was then heated to 75° C. and then charged with 40 psig ethylene. Isohexane (200 mL) was used to was used to chase a non-coordinating anion activator represented by the Formula:

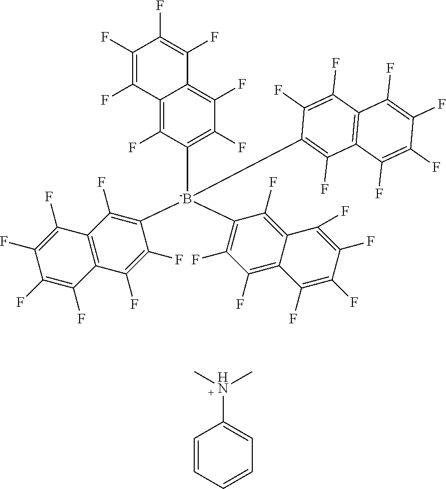

(25.1 mg, 5 mL toluene solution) and catalyst represented by the Formula:

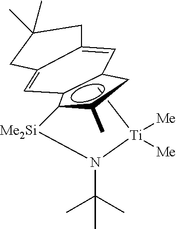

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 5: Preparation of Reference 3

A 2 L autoclave reactor was charged with tri(n-octyl)aluminum (TNOAL, 2.0 mL of 25 wt % hexane solution; obtained from Sigma Aldrich), 1-decene (300 mL), and isohexane (600 mL). The mechanical stir was set at 700 rpm. The reactor was then heated to 75° C. and then charged with 60 psig ethylene. Isohexane (200 mL) was used to chase a non-coordinating anion activator represented by the Formula:

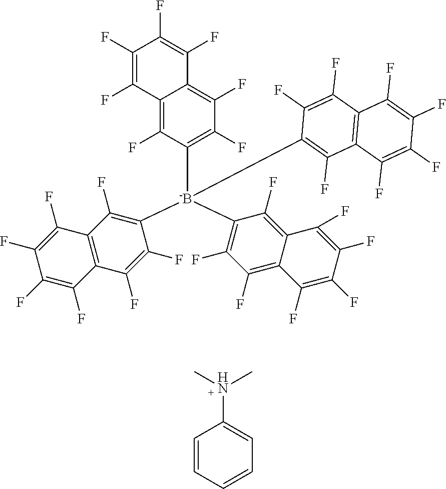

(25.1 mg, 5 mL toluene solution) and catalyst represented by the Formula:

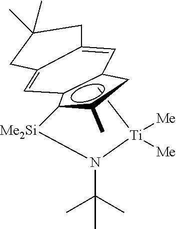

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 6: Preparation of Example 3

A 2 L autoclave reactor was charged with tri(n-octyl)aluminum (TNOAL, 2.0 mL of 25 wt % hexane solution; obtained from Sigma Aldrich), 1-decene (300 mL), ENB (10 mL), and isohexane (300 mL). The mechanical stir was set at 700 rpm. The reactor was then heated to 75° C. and then charged with 60 psig ethylene. Isohexane (200 mL) was used to chase a non-coordinating anion activator represented by the Formula:

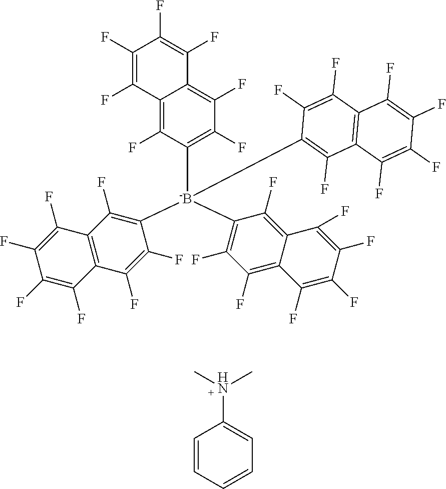

(25.1 mg, 5 mL toluene solution) and catalyst represented by the Formula:

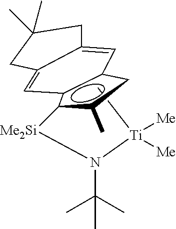

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 7: Preparation of Reference 4

A 2 L autoclave reactor was charged with tri(n-octyl)aluminum (TNOAL, 2.0 mL of 25 wt % hexane solution; obtained from Sigma Aldrich), 1-decene (300 mL), and isohexane (600 mL). The mechanical stir was set at 700 rpm. The reactor was then heated to 75° C. and then charged with 100 psig ethylene. Isohexane (200 mL) was used to chase a non-coordinating anion activator represented by the Formula:

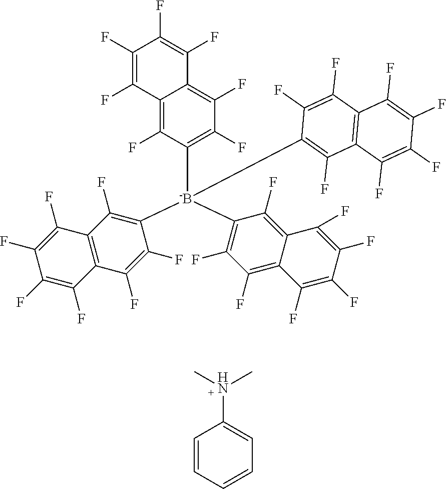

(25.1 mg, 5 mL toluene solution) and catalyst represented by the Formula:

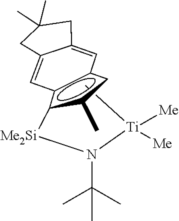

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 8: Preparation of Example 4

A 2 L autoclave reactor was charged with tri(n-octyl)aluminum (TNOAL, 2.0 mL of 25 wt % hexane solution; obtained from Sigma Aldrich), 1-decene (300 mL), ENB (10 mL), and isohexane (300 mL). The mechanical stir was set at 700 rpm. The reactor was then heated to 75° C. and then charged with 100 psig ethylene. Isohexane (200 mL) was used to chase a non-coordinating anion activator represented by the Formula:

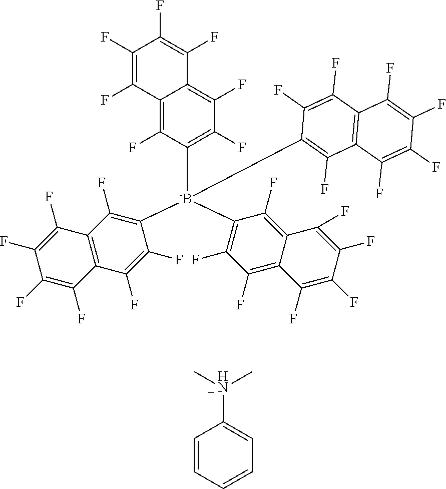

(25.1 mg, 5 mL toluene solution) and catalyst represented by the Formula:

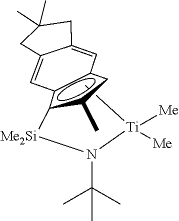

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 9: Preparation of Reference 5

A 2 L autoclave reactor was charged with tri(n-octyl)aluminum (TNOAL, 2.0 mL of 25 wt % hexane solution; obtained from Sigma Aldrich), 1-octadecene (380 mL), and isohexane (600 mL). The mechanical stir was set at 700 rpm. The reactor was then heated to 75° C. and then charged with 20 psig ethylene. Isohexane (200 mL) was used to chase a non-coordinating anion activator represented by the Formula:

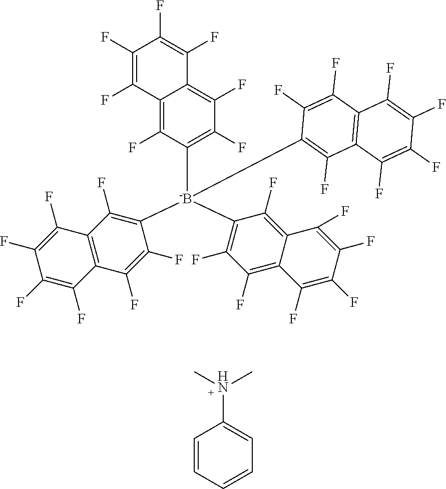

(25.1 mg, 5 mL toluene solution) and catalyst represented by the Formula:

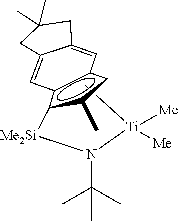

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 10: Preparation of Example 5

A 2 L autoclave reactor was charged with tri(n-octyl)aluminum (TNOAL, 2.0 mL of 25 wt % hexane solution; obtained from Sigma Aldrich), 1-octadecene (380 mL), ENB (10 mL), and isohexane (600 mL). The mechanical stir was set at 700 rpm. The reactor was then heated to 75° C. and then charged with 20 psig ethylene. Isohexane (200 mL) was used to chase a non-coordinating anion activator represented by the Formula:

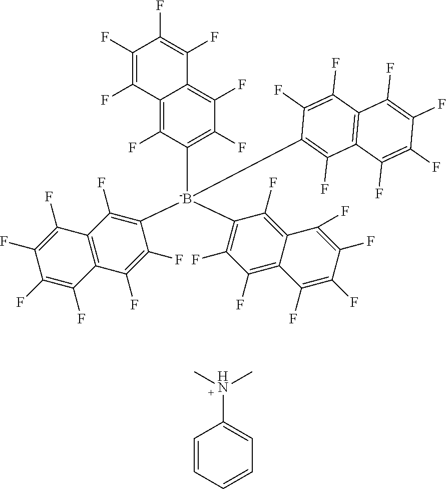

(25.1 mg, 5 mL toluene solution) and catalyst represented by the Formula:

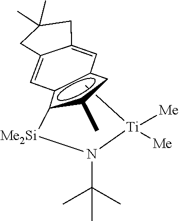

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 11: Preparation of Example 6

A 2 L autoclave reactor was charged with tri(n-octyl)aluminum (TNOAL, 2.0 mL of 25 wt % hexane solution; obtained from Sigma Aldrich), 1-octadecene (380 mL), ENB (10 mL), and isohexane (600 mL). The mechanical stir was set at 700 rpm. The reactor was then heated to 75° C. and then charged with 40 psig ethylene. Isohexane (200 mL) was used to chase a non-coordinating anion activator represented by the Formula:

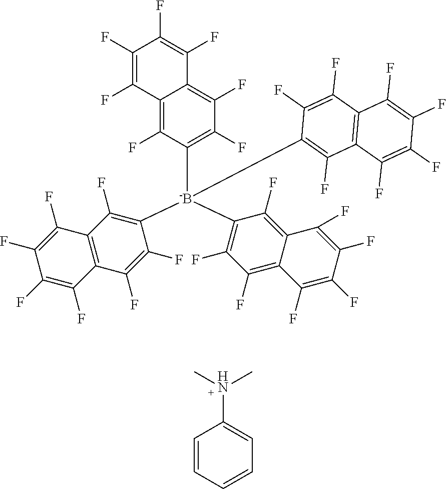

(25.1 mg, 5 mL toluene solution) and catalyst represented by the Formula:

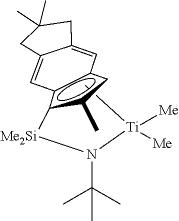

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

### Example 12: Preparation of Example 7

A 2 L autoclave reactor was charged with tri(n-octyl)aluminum (TNOAL, 2.0 mL of 25 wt % hexane solution; obtained from Sigma Aldrich), 1-octadecene (380 mL), ENB (10 mL), and isohexane (600 mL). The mechanical stir was set at 700 rpm. The reactor was then heated to 75° C. and then charged with 80 psig ethylene. Isohexane (200 mL) was used to chase a non-coordinating anion activator represented by the Formula:

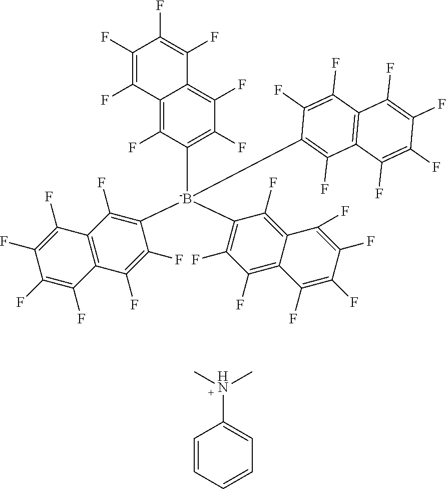

(25.1 mg, 5 mL toluene solution) and catalyst represented by the Formula:

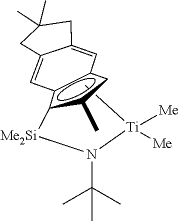

(8 mg, 5 mL toluene solution) into the reactor. Immediately following the injection of catalyst/activator, the ethylene value was left open to maintain a steady-state pressure. The polymerization was carried out at 80° C. for 30 minutes. The reaction was cooled to 30° C. and the pressure was released from vent valves. Polymer obtained was isolated by evaporation of volatiles under vacuum at 70° C. for 12 hours.

Polymer properties for each of the above-synthesized polymers were obtained and are presented below in reference to Table 1.

TABLE 1

| | C2/C18 | Diene | Mₙ | M_{w} | | | T_{C}, | T_{M}, | ΔHₘ |
|---|---|---|---|---|---|---|---|---|---|
| Polymer | Ratio | wt % | (kg/mol) | (kg/mol) | M_{w}/Mₙ | T_{g},° C. | ° C. | ° C. | J/g |
| Reference 1 | 0.00 | 0.00 | 63.2 | 146 | 2.31 | −68.63 | Amorphous | | |
| Example 1 | 0.14 | 2.39 | 58.6 | 127 | 2.17 | −67.92 | Amorphous | | |
| Reference 2 | 0.20 | 0.00 | 83.3 | 195 | 2.34 | −69.03 | Amorphous | | |
| Example 2 | 0.30 | 2.06 | 91.1 | 217 | 2.38 | −67.41 | Amorphous | | |
| Reference 3 | 0.31 | 0.00 | 95.2 | 224 | 2.36 | −67.56 | Amorphous | | |
| Example 3 | 0.20 | 3.47 | 82.1 | 184 | 2.24 | −64.40 | Amorphous | | |
| Reference 4 | 0.10 | 0.00 | 71.6 | 177 | 2.47 | −72.90 | 30.60 | 37.10 | 61.30 |
| Example 4 | 0.08 | 5.74 | 70.4 | 176 | 2.50 | −63.30 | 70.20 | 110.0 | 3.13 |
| Reference 5 | 0.15 | 0.00 | 110.9 | 241 | 2.17 | — | 28.20 | 35.70 | 102.0 |
| Example 5 | 1.27 | 4.28 | 117.6 | 252 | 2.14 | — | 23.0/30.9 | 32.4/37.6 | 156.0 |
| Example 6 | 0.82 | 3.93 | 121.5 | 262 | 2.15 | — | 22.1/30.1 | 32.0/36.8 | 187.0 |
| Example 7 | 1.53 | 3.23 | 178.8 | 410 | 2.29 | — | 15.2/30.28 | 25.0/37.0 | 176.0 |

### Example 13: Vulcanization Processes

Selected terpolymer samples were crosslinked using three different intitators: dicumyl peroxide (DCP), sulfur, and/or UV curing.

Vulcanization performed using DCP was achieved by dissolving five grams of selected terpolymer samples in hexanes along with different amounts of DCP at 60° C. The solutions were poured in aluminum dishes where solvent evaporates overnight under a fume hood and then solvent traces were removed in a vacuum oven at 70° C. for 3 hours.

Vulcanization performed using sulfur was achieved by mixing five grams (100 parts per hundred, phr) of selected terpolymer samples with 2 phr of superfine sulfur (99.5%, Akrochem), 0.5 phr of zinc stearate (Sigma-Aldrich), 0.2 phr of diphenyl guanidine, DCP (98%, TCI), and 0.2 phr of N-cyclohexyl-2-benzothiazole sulfonamide, CBS (>98%, TCI). The mixtures were masticated (ten times) in a hot press at 110° C. to distribute the additives evenly in the polymer matrix.

Vulcanization performed using UV curing was achieved by dissolving two grams of selected terpolymer samples in hexanes along with 1 wt % of the photoinitiator 1-hydroxycyclohexyl phenyl ketone at 60° C. The solutions were poured in aluminum dishes where solvent evaporates overnight under a fume hood and then solvent traces were removed in a vacuum oven at 70° C. for 3 hours.

### Example 14: Cure Kinetics Based on Vulcanization Processes

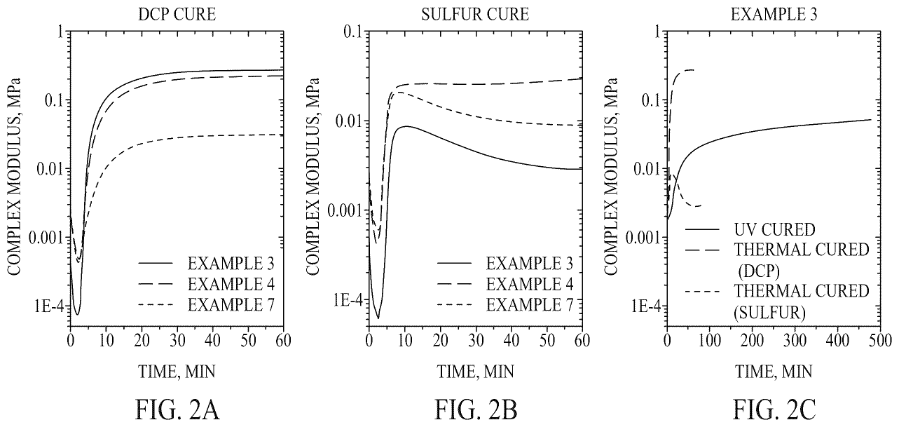

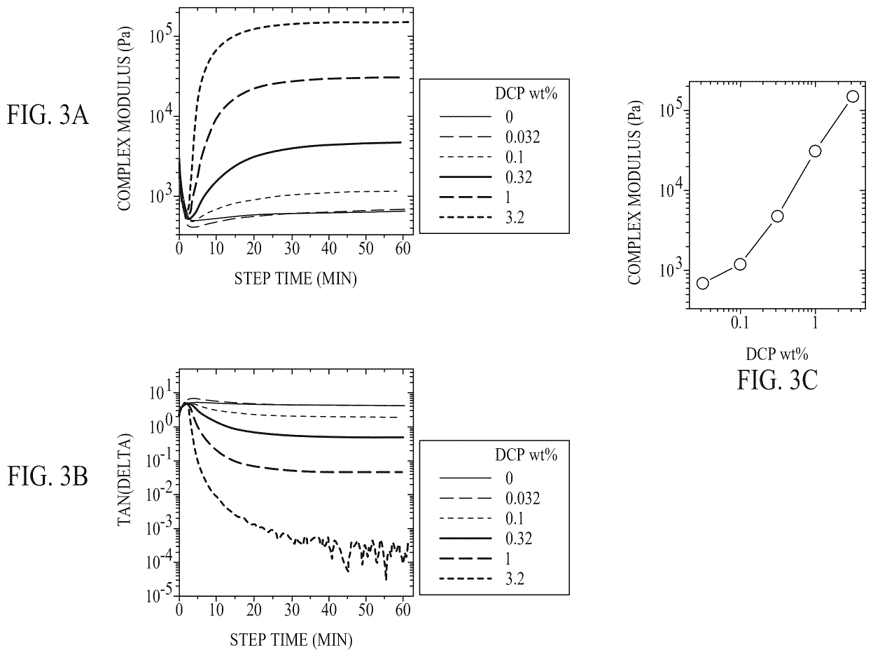

The cure kinetics of Example 3, Example 4, and Example 7 according to DCP, sulfur, and UV curing were measured using rotational rheometers (ARES-G2, TA-instruments), where the evolution of the complex modulus was tracked during 1 hour (h) of curing at 160° C. using DCP or sulfur, and the UV curing process was cross-linked by exposing the poly(alpha olefin) terpolymer to an ultraviolet (UV) light source (365 nm, 9.6 mW/cm2) for 5 hours, using the photocuring accessory for the ARES-G2 rheomether (TA Instruments), as shown in FIGS. 1A-1C. Final complex modulus, after 1 h of curing, as a function of DCP content was performed, where the effect of DCP content in the cured Example 7 indicated that the complex modulus can be adjusted across more than two orders of magnitude by varying the concentration of DCP added to the poly(alpha olefin) terpolymer, as shown in FIGS. 2A-2C.

### Example 15: Rheological Response of Terpolymer

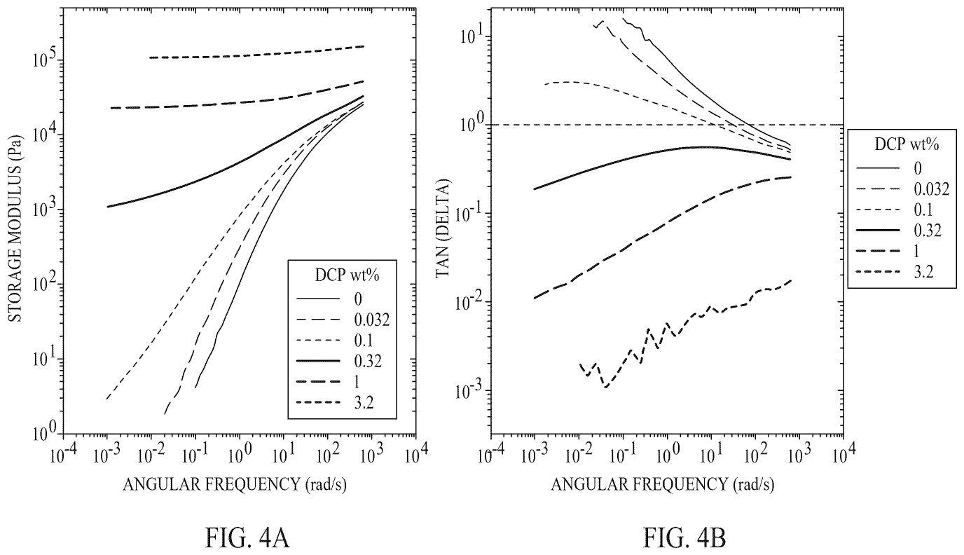

Dynamic frequency sweeps of Example 7 containing different amounts of DCP were cured for 1 h at 160° C. Measurements were carried out at 80° C. For a DCP content lower than 0.1%, the rheological response corresponded to long chain branched polymers, whereas for a DCP content larger than 0.1%, a second plateau modulus developed at low frequencies, indicating network formation, as shown in FIGS. 4A and 4B.

### Example 16: Tensile Strength of Terpolymer

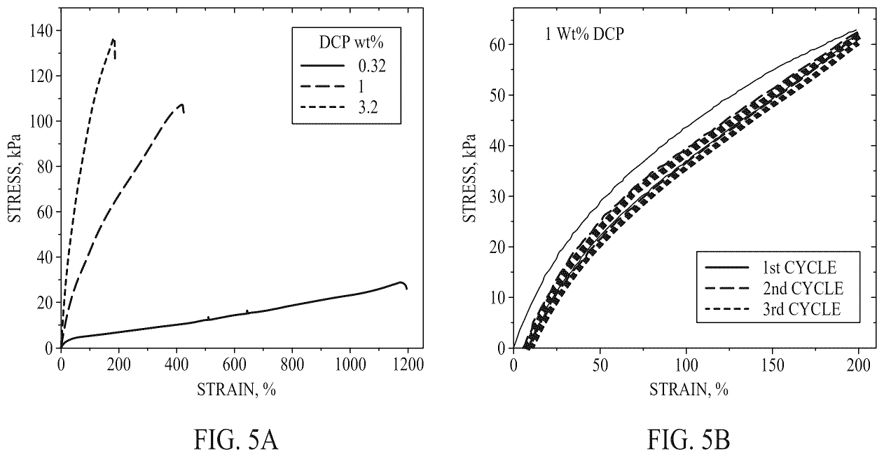

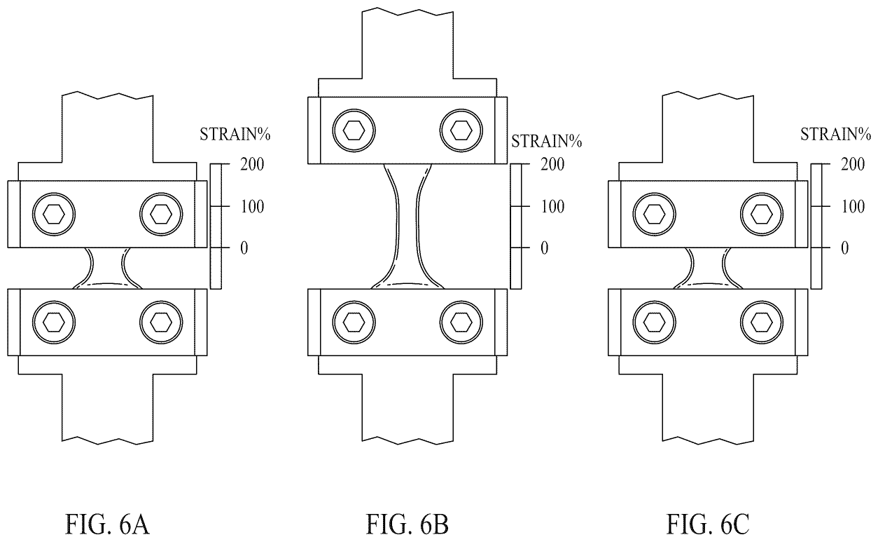

Stress-strain plots of cured Example 7 were determined for breakage of specimens with different DCP contents, as shown in FIG. 5A and hysteretic response with 1% DCP during 50 (loading-unloading) deformation cycles, as shown in FIG. 5B. The tensile response of the the cured Example 7 demonstrated the tunability of the tensile response of the PAO bottlebrush networks by changing the DCP content. The tensile response during 50 loading-unloading cycles of the sample with 1% DCP demonstrated the low hysteresis of this sample. The tensile strength of the poly(alpha olefin) terpolymer was also determined in a dogbone specimen before deformation, at 200% strain, and after a first loading-unloading cycle, as shown in FIGS. 6A-6C.

### Example 17: Compressive Strength of Terpolymer

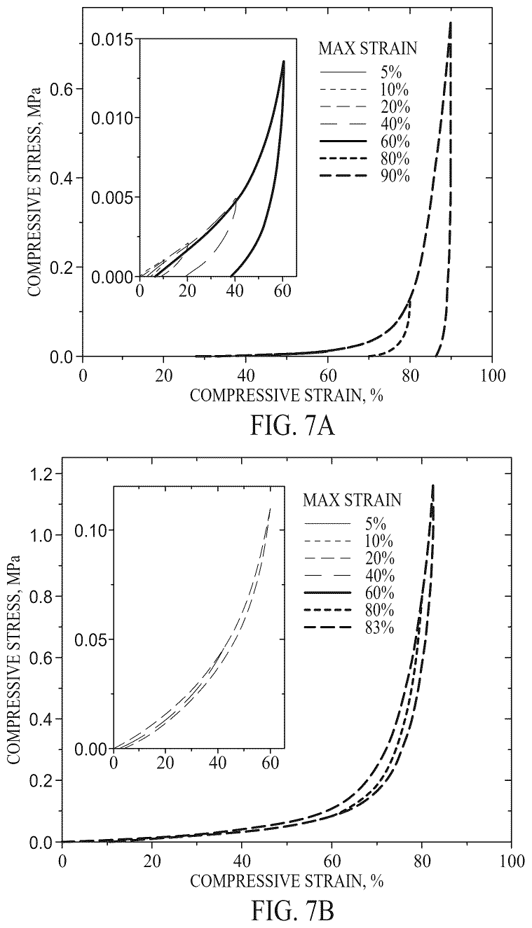

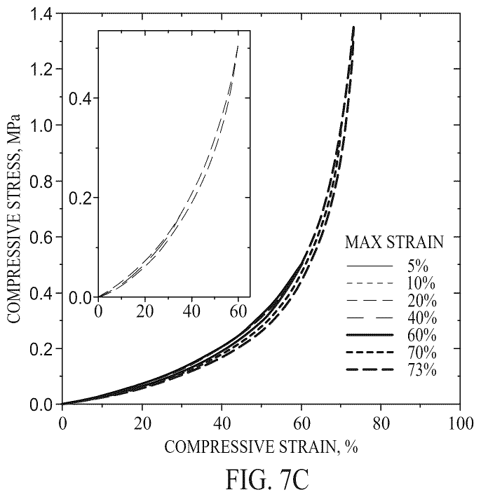

Compressive stress versus strain of cured Example 7 with DCP contents of 0.32%, 1%, and 3.2% were determined, as shown in FIGS. 7A, 7B, and 7C, respectively. The test consisted of multiple deformation cycles with successive increase in total strain. The response to compressive deformation of the the cured Example 7 resulted in increased hysteresis as the DCP concentration increased.

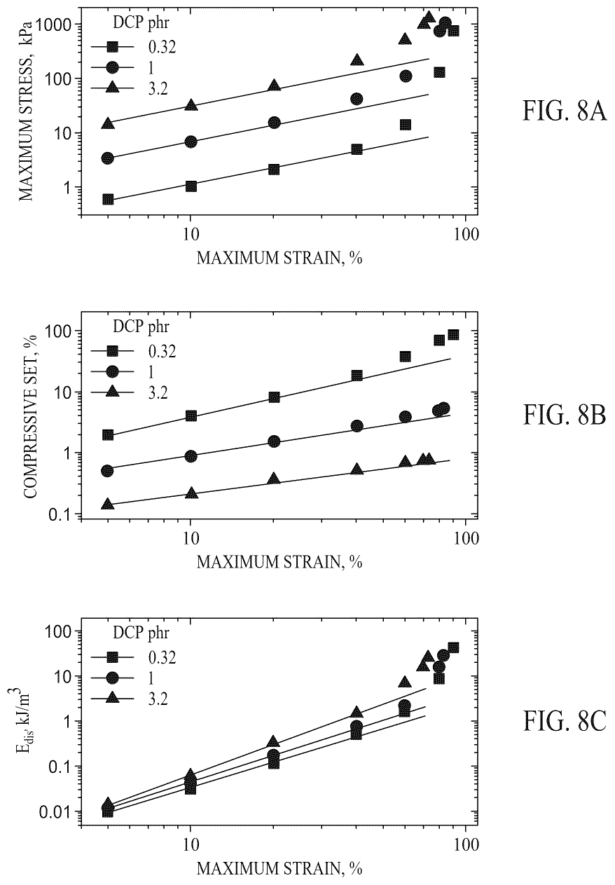

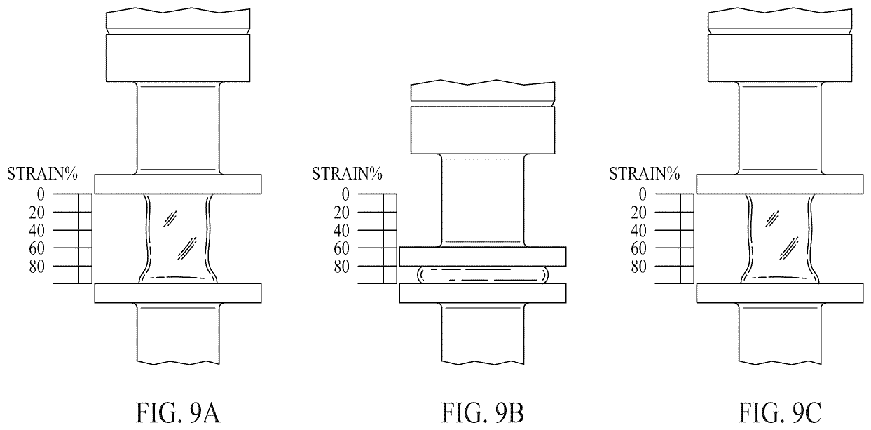

Compressive strength (maximum stress), compressive set, and hysteresis loss as a function of strain and DCP content for the cured Example 7 were determined, as shown in FIGS. 8A, 8B, and 8C, respectively. Increasing the DCP content in the elastomers resulted in an increase of the compressive strength (maximum stress) and a decrease in the compressive set, as shown in FIGS. 8A and 8B. The hysteresis loss slightly increased with increased DCP content; however the elastic hysteresis was reduced at strains lower than 80%, as shown in FIG. 8C. Images of the cured Example 7 containing 1% DCP were determined before deformation, at 80% compressive strain, and after a first loading-unloading cycle, which showed that a cylindrical specimen could fully recover its original shape after the large compression, as shown in FIGS. 9A-9C.

Overall, the present disclosure provides poly(alpha olefin) terpolymers having a reduced and/or hindered fluidity above a melting temperature of the poly(alpha olefin) terpolymer, thereby allowing phase change materials (PCMs) having reduced and/or eliminated leakage to be produced. Moreover, PCMS produced by the poly(alpha olefin) terpolymers of the present disclosure are self-supportive, thereby reducing and/or eliminating integration of porous supports with the poly(alpha olefin) terpolymers of the present disclosure. Without being bound by theory, the poly(alpha olefin) terpolymers of the present disclosure can include an elastic modulus in a range from about 1 kPa to about 0.2 MPa, a latent heat, measured by DSC, in a range from about 100 J/g to about 200 J/g, and melting temperatures in a range from about 15° C. to about 35° C., making them ideal candidates for PCM materials.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A method for preparing a poly(alpha olefin) terpolymer, the method comprising:
introducing ethylene, one or more linear α-olefin monomers, one or more non-conjugated diene monomers, and a catalyst system to a first reactor to form a reaction mixture, the catalyst system represented by Formula (V): 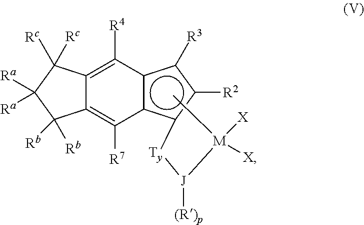
wherein:
M is a group 4 metal;
J is N, O, S, or P;
p is 1 when J is N or P, and is 0 when J is O or S;
each R², R³, R⁴, and R⁷ is independently hydrogen, or a C₁-C₅₀ substituted or unsubstituted hydrocarbyl, halocarbyl, silylcarbyl, or germylcarbyl;
R′ is a C₁-C₁₀₀ substituted or unsubstituted hydrocarbyl, halocarbyl, silylcarbyl, substituted hydrocarbyl rings, unsubstituted hydrocarbyl rings, substituted heterocyclic rings, or unsubstituted heterocyclic rings each having 5, 6, 7, or 8 ring atoms;
T is (CR⁸R⁹)ₓ, SiR⁸R⁹ or GeR⁸R⁹ where x is 1 or 2, each R⁸ and R⁹ is independently selected from hydrogen or substituted or unsubstituted hydrocarbyl, halocarbyl, silylcarbyl, and germylcarbyl and R⁸ and R⁹ may optionally be bonded together to form a ring structure;
y is 0 or 1;
each X is C₁-C₁₀₀ alkyl; and
each R^{a}, R^{b}, and R^{c} is independently C₁-C₁₀ alkyl or hydrogen;
polymerizing the reaction mixture to form a linear polymer; and
vulcanizing the polymer mixture to form a polymer composition comprising the poly(alpha olefin) terpolymer.

2. The method of claim 1, one or more linear α-olefin monomers are substituted or unsubstituted C₂ to C₄₀ alpha olefins.

3. The method of claim 2, wherein the one or more α-olefin monomers are unsubstituted C₁₀ to C₁₈ alpha olefins.

4. The method of claim 3, wherein the wherein the one or more α-olefin monomers are decene or 1-octadecene.

5. The method of claim 1, wherein the one or more non-conjugated diene monomers are substituted or unsubstituted C₂ to C₄₀ olefins.

6. The method of claim 5, wherein the one or more non-conjugated diene monomers are selected from the group consisting of 2-ethylidene-5-norborene, 5-vinyl-2-norbornene, norbornadiene, 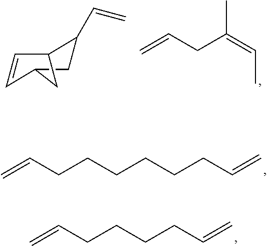
and any combination thereof.

7. The method of claim 5, wherein the one or more non-conjugated diene monomers are 2-ethylidene-5-norborene.

8. The method of claim 1, wherein vulcanizing the polymer mixture comprises performing a chemical curing process or a UV curing process.

9. The method of claim 8, wherein vulcanizing comprises the chemical curing process, and wherein performing the chemical curing process comprises introducing a crosslinking agent to the linear polymer.

10. The method of claim 9, wherein the crosslinking agent comprises an organic peroxide or sulfur.

11. The method of claim 8, wherein vulcanizing comprises the UV curing process, and wherein performing the UV curing process comprises introducing a photo-initiator to the linear polymer and exposing the linear polymer to a UV light source comprising a wavelength of about 100 nm to about 500 nm.

12. A polymer composition, the polymer composition comprising a poly(alpha olefin) terpolymer prepared from a reaction product of:
ethylene,
one or more linear α-olefin monomers comprising an unsubstituted C₂ to C₄₀ alpha olefins,
and one or more non-conjugated diene monomers selected from the group consisting of 2-ethylidene-5-norborene, 5-vinyl-2-norbornene, norbornadiene, 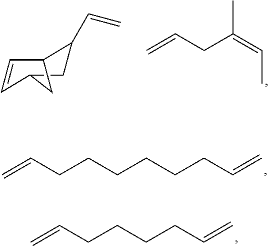
and any combination thereof,
wherein the poly(alpha olefin) terpolymer comprises a complex modulus of about 1 kPa to about 100 kPa.

13. The polymer composition of claim 12, wherein the poly(alpha olefin) terpolymer comprises a non-conjugated diene content of less than 10 wt %.

14. The polymer composition of claim 12, wherein the poly(alpha olefin) terpolymer comprises an elastic modulus of about 1 kPa to about 2 MPa.

15. The polymer composition of claim 12, wherein the poly(alpha olefin) terpolymer comprises a tensile strength in a range from about 30 kPa to about 140 kPa, a strain at break in a range from about 200% to about 1,200%, and a permanent set in a range from about 1% to about 5%.

16. The polymer composition of claim 12, wherein the poly(alpha olefin) terpolymer comprises a compressive strength in a range from about 1 MPa to about 1.6 MPa, a compressive set at compressive strains of less than 80% ranging about 1% to about 10%, and a hysteresis loss energy of less than 1 kJ/m³.

17. The polymer composition of claim 12, wherein the poly(alpha olefin) terpolymer comprises a melting temperature of about 20° C. to about 130° C., and a latent heat of about 3 J/g to about 200 J/g.

18. The polymer composition of claim 17, wherein the poly(alpha olefin) terpolymer comprises a melting temperature of about 15° C. to about 35° C., and a latent heat of less than 100 J/g.

19. The polymer composition of claim 12, wherein the poly(alpha olefin) terpolymer comprises a storage modulus of about 1 Pa to about 100 kPa, and a maximum stress of about 0.1 kPa to about 1,000 kPa.

20. The polymer composition of claim 12, wherein the one or more non-conjugated diene monomers comprise 2-ethylidene-5-norborene, and the poly(alpha olefin) terpolymer is represented by Formula (XI): 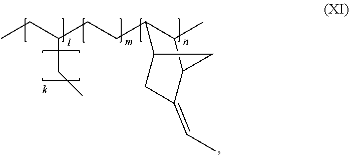
wherein each of k, l, m, and n is independently an integer of greater than 1.
